(19) United States
(12) Patent Application Publication
(10) Pub. No.: US 2025/0357801 A1
(43) Pub. Date: Nov. 20, 2025

(54) Three-Dimensional-Flux Electric Motor And Method For Making Thereof

(71) Applicant: Persimmon Technologies Corporation, Wakefield, MA (US)

(72) Inventors: Jayaraman Krishnasamy, Boxborough, MA (US); Martin Hosek, Salem, NH (US); Morteza Taghavi, Wakefiled, MA (US); Brett Guralnick, Wakefield, MA (US); Ankur Gupta, Wakefield, MA (US); Mark Talmer, Pepperell, MA (US)

(21) Appl. No.: 19/206,386

(22) Filed: May 13, 2025

Related U.S. Application Data
(60) Provisional application No. 63/647,288, filed on May 14, 2024.

(51) Int. Cl. H02K 1/02; H02K 1/14; H02K 15/022; H02K 21/24

(52) U.S. Cl. CPC H02K 1/02; H02K 1/146; H02K 15/022; H02K 21/24

(57) ABSTRACT

A stator for an axial flux motor includes: a yoke, a plurality of teeth arranged on the yoke and spaced from each other, each tooth of the plurality of teeth including a sprayed soft-magnetic composite material including a matrix of ferro-magnetic domains separated by insulation layers, and a coil over each tooth, the coil over each tooth being connected to coils on adjacent teeth. Each tooth of the plurality of teeth includes a body portion having three sides, each of the three sides having a bottom edge and a top edge, and a top portion located on the top edges. The top portion includes an overhang portion that overhangs the top edges of the body portion. Each tooth of the plurality of teeth provides for a magnetic flux flow in the spray-formed composite material in axial, radial, and circumferential directions.

### CROSS REFERENCE

This application claims priority under 35 USC 119 (e) to U.S. Provisional Application No. 63/647,288, filed May 14, 2024, which is hereby incorporated by reference in its entirety.

### BACKGROUND

### Technical Field

The example and non-limiting embodiments relate generally to an electric motor and, more particularly, to a three-dimensional-flux electric motor and method for making such motor.

### Brief Description of Prior Developments

Electric motors are generally used to provide translational or rotational motion to the various moving elements of automated mechanical devices. The electric motors used typically comprise rotating elements (rotors) assembled with stationary elements (stators). Magnets are located between the rotating and stationary elements or directly on the rotating element. Coils are wound around soft iron cores on the stationary elements and are located proximate the magnets.

In operating an electric motor, an electric current is passed through the coils, and a magnetic field is generated, which acts upon the magnets. When the magnetic field acts upon the magnets, one side of the rotating element is pushed and an opposing side of the rotating element is pulled, which thereby causes the rotating element to rotate relative to the stationary element. Efficiency of the rotation is based at least in part on the shape of the magnetic components used and the characteristics of the materials used in the fabrication of the electric motor.

### SUMMARY

The following summary is merely intended to be exemplary. The summary is not intended to limit the scope of the claims.

In accordance with one aspect, a method of making a stator comprises providing a yoke, wherein the yoke comprises a spray-formed yoke; providing a tooth ring, wherein the tooth ring comprises a spray-formed tooth ring; separating portions of the tooth ring to form a plurality of teeth; arranging the separated teeth in a circular pattern, wherein each separated tooth is spaced from an adjacent tooth; inserting a coil over each separated tooth, wherein the coil comprises two lead wires extending from a same face of each coil; locating the yoke onto the plurality of teeth; placing a housing onto the yoke; and connecting the coils to each other at the two lead wires extending from the same face of each coil.

In accordance with another aspect, a method of making a stator comprises providing a yoke, wherein the yoke comprises a spray-formed yoke; providing a tooth ring, wherein the tooth ring is a spray-formed tooth ring; separating portions of the tooth ring to form a plurality of teeth; arranging the separated teeth in a circular pattern, wherein each separated tooth is spaced from an adjacent tooth; inserting a coil over each separated tooth; locating the yoke onto the plurality of teeth; placing the yoke into an encapsulation mold; connecting the coils to each other; and injecting a resin into the encapsulation mold.

In accordance with another aspect, a method of assembling a stator/rotor assembly for a motor comprises providing a housing having a bearing sleeve, the bearing sleeve extending radially inward in the housing; providing a stator, wherein the stator comprises a spray-formed stator yoke, a plurality of teeth arranged in a spaced relationship on the stator yoke, and a coil inserted over each of the separated teeth and connected to coils inserted over adjacent separated teeth; mounting the stator in the housing on the bearing sleeve; mounting bearings proximate the bearing sleeve; and mounting a rotor comprising a rotor yoke and a plurality of magnets on the bearing sleeve, wherein mounting the rotor on the bearing sleeve comprises inserting the rotor into the housing using a gradual and controlled insertion such that an air gap is formed between the stator and the rotor, the air gap being substantially planar and normal to an axis of rotation of the rotor relative to the stator.

In accordance with another aspect, a stator for a three-dimensional flux electric motor comprises a stator yoke; a plurality of teeth arranged on the stator yoke, wherein teeth of the plurality of teeth are spaced from each other; and a coil located over each tooth, the coils over each tooth being connected to coils on adjacent teeth. Each tooth of the plurality of teeth includes a body portion having three sides connected along respective opposing side edges, each of the three sides having a bottom edge and a top edge adjacent to the opposing side edges, and a top portion located on the top edges. The top portion of each tooth includes an overhang portion that overhangs the top edges of the body portion. Each tooth of the plurality of teeth provides for at least a magnetic flux flow in axial, radial, and circumferential directions.

In accordance with another aspect, a three-dimensional flux electric motor comprises a housing comprising a bearing sleeve extending radially inward in the housing; at least one stator mounted on the bearing sleeve in the housing, the at least one stator comprising a spray-formed stator yoke, a plurality of teeth arranged on the stator yoke and spaced from each other, and a coil over each tooth, the coils over each tooth being connected to coils on adjacent teeth, each tooth of the plurality of teeth including a body portion having three sides, each of the three sides having a bottom edge and a top edge and a top portion located on the top edges, the top portion including an overhang portion that overhangs the top edges of the body portion, each tooth of the plurality of teeth providing for a magnetic flux flow in axial, radial, and circumferential directions; and at least one rotor mounted on the bearing sleeve, the at least one rotor comprising a rotor yoke, and a plurality of magnets on the rotor yoke. The at least one stator and the at least one rotor are separated by an air gap.

In accordance with another aspect, a stator for an axial flux motor comprises: a yoke, a plurality of teeth arranged on the yoke and spaced from each other, each tooth of the plurality of teeth comprising a sprayed soft-magnetic composite material comprising a matrix of ferro-magnetic domains separated by insulation layers, and a prefabricated coil over each tooth, the coil over each tooth being connected to coils on adjacent teeth. Each tooth of the plurality of teeth includes a body portion having three sides, each of the three sides having a bottom edge and a top edge, and a top portion located on the top edges. The top portion includes an overhang portion that overhangs the top edges of the body portion. Each tooth of the plurality of teeth provides for a magnetic flux flow in the spray-formed composite material in axial, radial, and circumferential directions.

In accordance with another aspect, a method of making a stator for an axial flux flow motor comprises: providing a yoke; spray-forming a tooth ring as a sprayed soft-magnetic composite material comprising a matrix of ferro-magnetic domains separated by insulation layers; separating portions of the tooth ring to form a plurality of teeth; arranging the separated teeth in a circular pattern, wherein each separated tooth is spaced from an adjacent tooth; inserting a coil over each separated tooth, wherein the coil comprises two lead wires extending from a same face of each coil; locating the yoke onto the plurality of teeth; placing a housing onto the yoke; and connecting the coils to each other at the two lead wires extending from the same face of each coil.

In accordance with another aspect, a method of forming a motor component in a near-net manner comprises providing a mold as a target, the mold having a cavity defined therein; spinning the mold about an axis extending through a center of the build plate; translating a spray gun of a spray-deposition system in a radial direction relative to the axis; spraying, from the spray-deposition system, a beam of soft-magnetic composite material comprising particles having a core-shell structure, onto the mold; angling the beam of sprayed soft-magnetic composite material at an inside corner defined by at least two walls of the mold; and removing the motor component formed by the sprayed soft-magnetic composite material from the mold.

In accordance with another aspect, an axial flux motor comprises a housing comprising a bearing sleeve axially positioned in the housing; at least one stator mounted on the bearing sleeve, the at least one stator comprising a spray-formed stator yoke, a plurality of teeth arranged on the spray-formed stator yoke and spaced from each other, each tooth of the plurality of teeth comprising a sprayed soft-magnetic composite material comprising a matrix of ferro-magnetic domains separated by insulation layers, and a prefabricated coil over each tooth, the coil over each tooth being connected to coils on adjacent teeth. Each tooth of the plurality of teeth includes a body portion having three sides, each of the three sides having a bottom edge and a top edge, and a top portion located on the top edges, wherein the top portion includes an overhang portion that overhangs the top edges of the body portion, and wherein each tooth of the plurality of teeth provides for a magnetic flux flow in the spray-formed soft-magnetic composite material in axial, radial, and circumferential directions. The axial flux motor also comprises at least one rotor mounted on the bearing sleeve, the at least one rotor comprising, a rotor yoke, and a plurality of magnets on the rotor yoke, wherein the at least one spray-formed stator and the at least one rotor are separated by an air gap.

### BRIEF DESCRIPTION OF THE DRAWINGS

The foregoing aspects and other features are explained in the following description, taken in connection with the accompanying drawings, wherein:

FIG. 1 is a perspective view of one example embodiment of a motor;

FIG. 2 is a cross sectional view of the example motor of FIG. 1;

FIG. 3 is a phantom perspective view of teeth on a yoke of an example stator illustrating magnetic flux flow in axial, radial, and circumferential directions;

FIG. 4 is a perspective view of one example of a stator winding core and coil assembly;

FIGS. 5A and 5D are perspective views of example stator teeth;

FIG. 5B is a perspective view of an example coil;

FIG. 5C is a perspective view of an example yoke illustrating alignment features at an edge thereof;

FIG. 6 is a flow diagram of an example fabrication process for a yoke and a tooth ring and an assembly of the yoke and teeth with a rotor;

FIG. 7A is a perspective view of a locating plate;

FIG. 7B are perspective and plan views of the locating plate of FIG. 7A with teeth mounted thereto;

FIG. 7C is a perspective view of the teeth, coils and locating plate of FIG. 7B with a yoke mounted on the teeth and coils;

FIG. 8 is a perspective view of an example housing for the stator;

FIG. 9 is a schematic representation of an example encapsulation of the stator in the housing and clearances between coils and the housing, coils and teeth, and the yoke and the housing;

FIG. 10 is a perspective view of the assembled motor with the stator located in the housing;

FIG. 11 is a cross sectional view of an example bearing assembly for use with the example stators described herein;

FIG. 12A is a plan view of stator components and subassemblies;

FIG. 12B is a perspective view of coil-wound teeth on a fixture plate and a yoke;

FIG. 12C is a perspective view of one example of an encapsulated stator and bearing assembly after the removal of the fixture plate;

FIGS. 13A and 13B are illustrations of an example rotor;

FIG. 14 is a perspective view of an example stator in which coils are inserted or wound onto respective stator teeth;

FIG. 15 is an example of a stator/rotor assembly using dual stators sandwiching a single rotor;

FIG. 16 is an example of a stator/rotor assembly using dual rotors sandwiching a single stator;

FIG. 17 is a perspective view of an example assembly process using magnets;

FIGS. 18A and 18B are side and perspective representations, respectively, of one example of a spray-formed material having a geometry defined by tapered edges;

FIG. 18C is a scanning electron microscope image of core-shell particles;

FIG. 18D is an optical micrograph showing a cross-section of spray-formed material;

FIG. 19 is a perspective view of one example apparatus used for spray-forming a near-net shaped component;

FIGS. 20A, 20B, 20C, and 20D are top views of the spray apparatus of FIG. 19 at different positions;

FIG. 21 is a schematic view of one example of a multiple station setup for spray-forming;

FIG. 22 is a perspective view of one example of a spray-formed disk shaped component;

FIG. 23 is a schematic view of a disk setup showing a disk mold assembly and spray gun direction;

FIG. 24 is a schematic view of a desired variation in angle of incidence of a particle beam with respect to a mold;

FIG. 25 is a graphical representation of build plate rotational direction and translation speeds;

FIG. 26 is a schematic view of a shape and placement of an air knife relative to a build plate;

FIG. 27 is a sectional view of radiused edges on a mold plug;

FIG. 28 is a process flow diagram showing an example mold fill and removal process;

FIG. 29 is a perspective view of one example of a disk-shaped component having a center void;

FIG. 30 is a perspective view of an example mold assembly including a center mold part;

FIG. 31 is a schematic view of angles of incidence of particle beams received at various points;

FIG. 32 is a process flow diagram showing one example of a fill and removal process for a cylinder near-net shaped component;

FIG. 33 is a perspective view of an example geometry of a stepped edge disk with a stepped center hole;

FIG. 34 is a process diagram showing an example of a deposition process and near-net shaped component removal for a stepped feature disk part with a stepped center hole;

FIGS. 35A and 35B are example geometries of rectangular parts and tapered edges on components;

FIG. 36 is a perspective view of a rectangular mold assembly with multi-part mold walls;

FIG. 37 is a perspective view of a process of removing walls following the filling of a mold cavity in a rectangular mold;

FIG. 38 is a schematic representation of various components of an axial flux motor; and

FIG. 39 is a cutaway sectional view of an axial flux motor.

### DETAILED DESCRIPTION

The present invention describes examples of electric motors and methods to fabricate such motors, including methods to fabricate stators of the motors. In such motors, the stator may be made of a spray-formed isotropic soft-magnetic composite material that facilitates magnetic flux flow in three independent spatial directions: axial, radial, and circumferential. Flux flow in three dimensions facilitates motor designs that maximize flux flow to yield higher power density compared to conventional two-dimensional flux flow stator cores. The spray-forming process enables production of stator core shapes in a near-net manner, thereby reducing the need for expensive machining operations. Such materials and methods are disclosed, for example, in US Patent Nos. 10,622,848; 10,170,946; and 9,887,598; and in US Patent Publication No. 2016/0197523, U.S. Patent Publication No. 2024/0291359, and U.S. Patent Publication No. 2024/0291360, all of which are incorporated by reference herein in their entireties. Methods to produce spray-formed soft-magnetic composite materials in near-net manner and soft-magnetic composite materials may be used in the fabrication of electric motors. For example, U.S. Pat. No. 9,205,488 describes a soft-magnetic material produced by a spray-forming process, and U.S. Patent Publication No. 2013/0000860 describes a spray-forming process based on layered particle deposition.

Soft-magnetic composite materials may be produced using sintering, compaction, and spraying techniques. Soft-magnetic composite materials can be formed with low internal conductivity by causing parts formed with the materials to have electrically insulating boundaries.

One method for creating a soft-magnetic composite material would be to use an epoxy or organic binder to hold particles together, while the epoxy serves as an insulation. This approach generates low eddy loss, although the density of the solid material is low. A sufficient mass of epoxy is desired to encapsulate the particles. The magnetic permeability of a material is directly proportional to the cross sectional area of ferro-magnetic domains. It is desirable for motor, transformer, and inductor applications to achieve the highest permeability possible. Therefore, a soft-magnetic structure for use in embodiments described herein would have a high ferro-magnetic density separated by periodic insulation layers. The insulation layer(s) should be as thin as possible to maximize the ferro-magnetic material, but they should also be sufficiently thick to electrically insulate the ferro-magnetic domains. The ferro-magnetic domain size range can range from 50 micrometers (μm) to 250 μm depending upon the final use case.

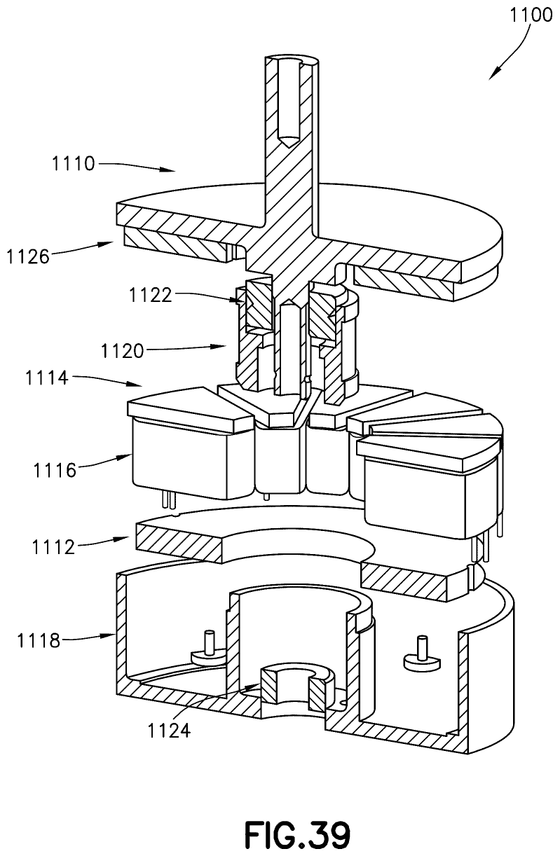

Soft-magnetic composite materials having desired structure for motor components and other elements described herein may be formed by spray-forming using techniques such as high velocity oxy-fuel (HVOF) or high velocity air fuel (HVAF). In processes using HVAF, however, parts manufactured may be post-machined in order to produce final parts compatible with motor designs. Since building solid parts with spray-forming techniques may result in tapered edges, high roughness, and material waste, and since straight and smooth cylindrical surfaces may be desired but possibly difficult to achieve with current approaches, it may be advantageous to utilize the material properties HVAF spray-forming of parts generates while also forming part geometry with minimal post-processing. Thus, as described herein, techniques for forming near-net shape soft-magnetic composite material parts with features within 0.125 μm dimensional tolerance while maintaining desirable magnetic properties may be employed. One particular example of a resulting near-net shape fabrication methodology may be seen at least with regard to an axial flux motor, as shown in FIG. 39 below.

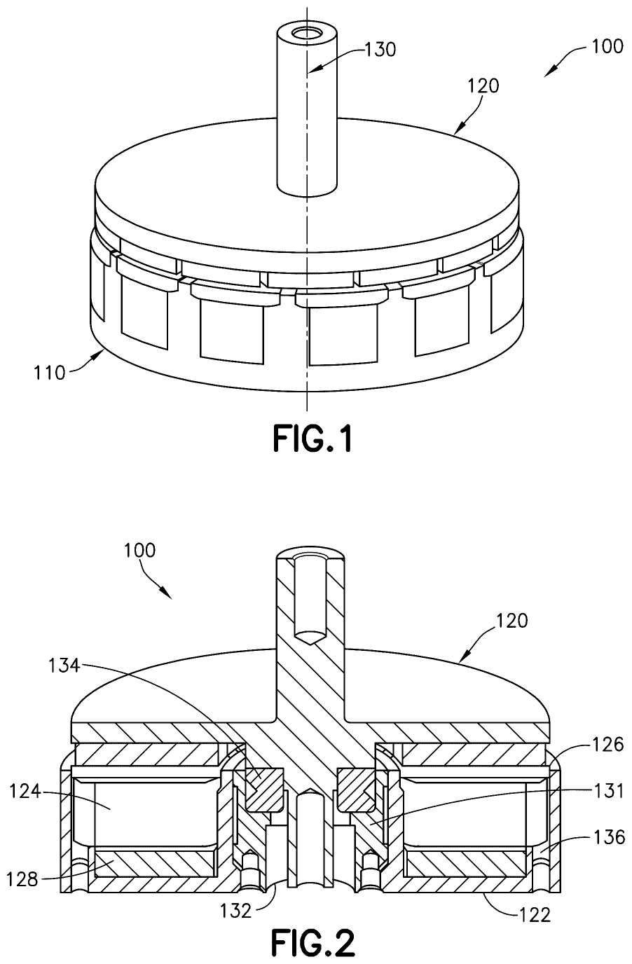

Referring to FIGS. 1 and 2, one example of a motor is shown generally at 100. The motor 100 may be a hybrid field-motor and includes a stator 110 and a rotor 120. The stator 110 and the rotor 120 are assembled so that a torque producing air gap between them is substantially planar and normal to an axis of rotation 130. The flux flow direction in the air gap is nominally parallel to the axis of rotation 130.

In FIG. 2, a cross section of the motor 100 is shown. The stator 110 comprises coils 124, stator teeth 126, and a backing ring or yoke 128 and may be located in a housing 122. A bearing sleeve 131 extends into the housing 122. Motor bearings are contained in the bearing sleeve 131, which is removable and replaceable. This helps with motor maintenance. In particular, radial bearings 132 and thrust bearings 134 are mounted in the bearing sleeve 131 to facilitate the rotation of the rotor 120 relative to the stator 110. A space 136 is formed in the housing 122 to accommodate the routing of interconnecting wires.

Referring to FIG. 3, magnetic flux flow in the stator 110, though predominantly axial, has radial and circumferential components. The stator teeth 126, shown here without coils 124, each have a main section 146 mounted on the yoke 128 with a tooth overhang 150 on top of the main section 146. The stator teeth 126 are designed to provide for the magnetic flux flow in the axial, radial, and circumferential directions. Magnetic flux flow in the radial and circumferential directions is facilitated by the tooth overhangs 150 on the edges of the main section 146. Such radial and circumferential components facilitate an increase in the overall effective air gap area.

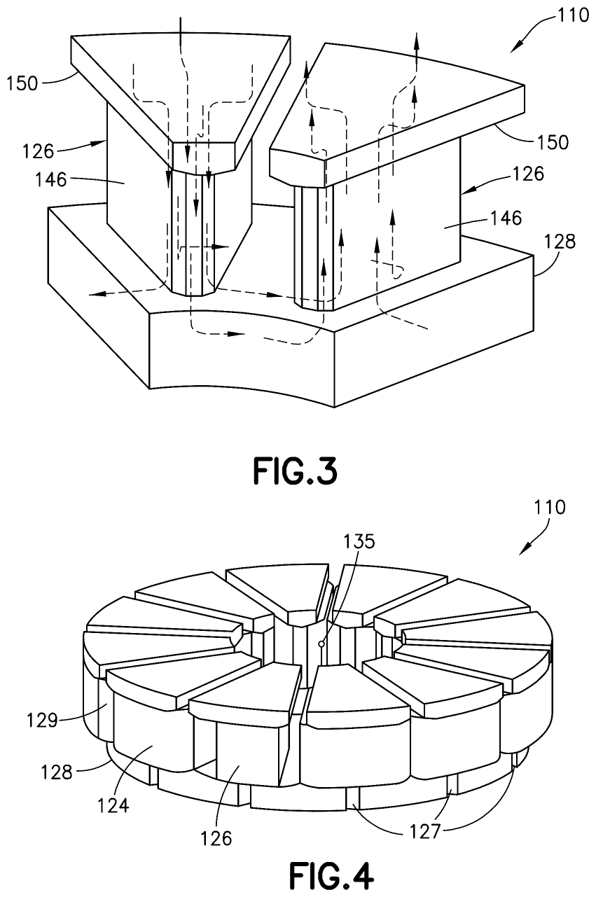

Referring now to FIG. 4, one example of a stator winding core and coil assembly of the stator 110 is shown. The stator winding core and coil assembly comprises the stator yoke 128 and multiple teeth (twelve teeth 126 are shown in the particular example of FIG. 4) and multiple formed coils 124 (twelve formed coils are shown in the particular example of FIG. 4). One tooth 126 is shown without a coil 124. Alignment features 127 are formed in the yoke 128 to facilitate the alignment of the yoke 128 in the housing 122. Spaces 129 defined between the coils 124 are used for soldered interconnections. A thermistor bulb 135 may be located in the stator yoke 128 to sense temperatures.

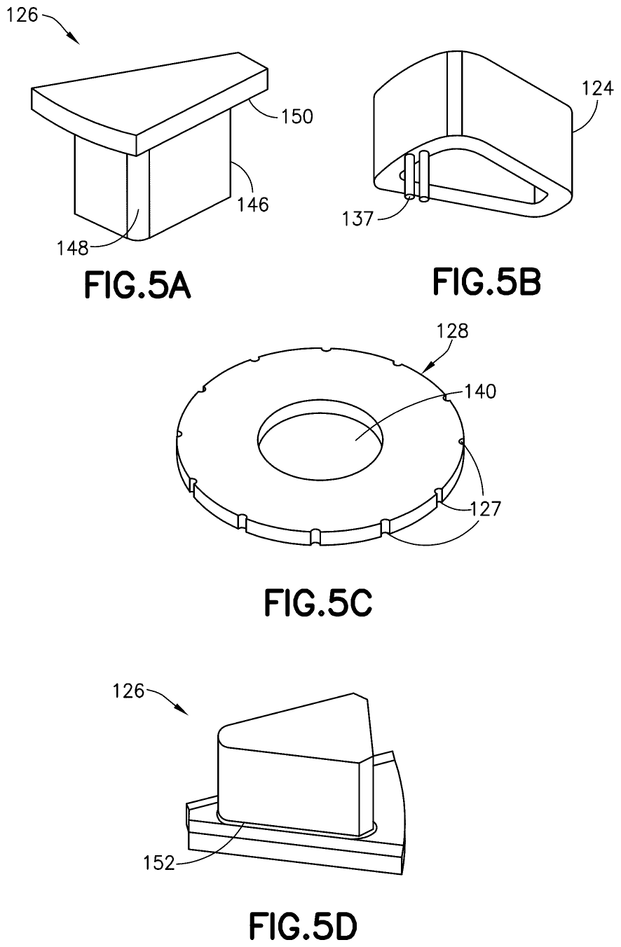

Referring now to FIGS. 5A, 5B, 5C, and 5D, examples of individual stator teeth 126, an individual coil 124, and the yoke 128 (or backing ring) are shown. As shown in FIG. 5C, the yoke 128 is a planar disk with a center hole 140 and the alignment features 127 to locate the yoke 128 with respect to the housing 122 and the stator teeth 126.

As shown in FIGS. 5A and 5D, the stator teeth 126 each have the main section 146 having chamfered or rounded outside corners 148 and a tooth overhang 150 that extends over the main section 146. A fillet 152 (FIG. 5D) may be disposed at an inside corner of the stator tooth 126 between the tooth overhang 150 and the main section 146. The fillets 152 at the inside corners minimize stress concentration. The chamfered or rounded surfaces of the outside corners accommodate the inside radii of the coils 124. The coils 124 are located over the main sections 146 of the teeth 126. As shown in FIG. 5B, coil lead wires 137 extend from a lower edge of each coil 124.

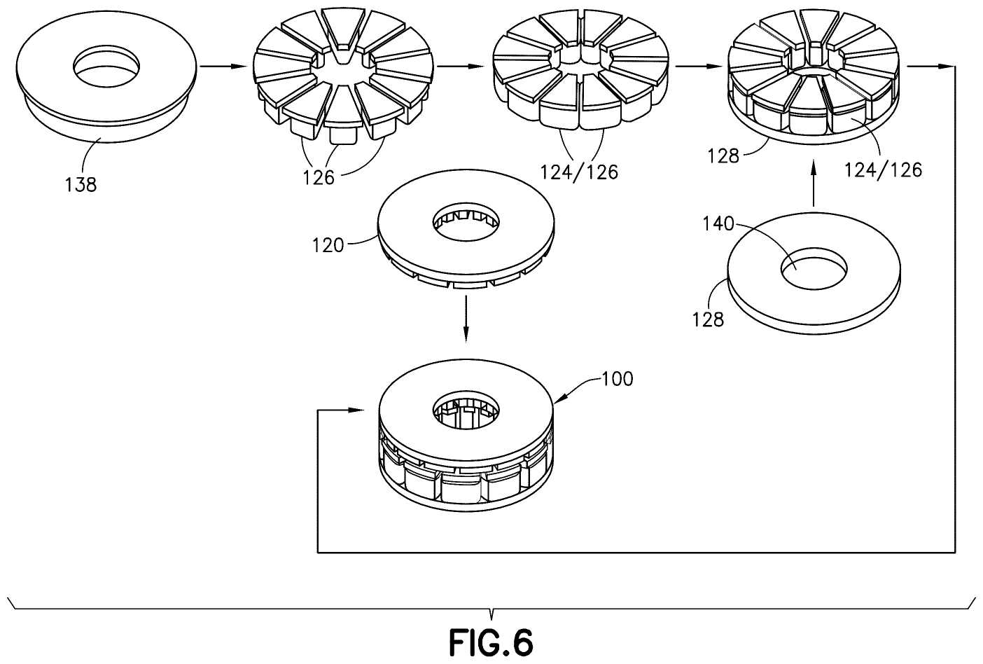

FIG. 6 illustrates one example of a fabrication process for the yoke 128 and a tooth ring 138 from which the teeth 126 are formed, as well as an assembly of the yoke 128 and teeth 126 with the rotor 120 to form the motor 100. As shown in FIG. 6, the stator yoke 128 may be spray-formed as an axially-symmetric disk with the center hole 140 and produced in a near-net manner. The tooth ring 138 may also be spray-formed as an axially-symmetric disk with a stepped outer edge and a stepped center hole and be produced in a near-net manner. The tooth ring 138 is then cut into multiple teeth 126 (twelve in this particular example) such that slots are defined between adjacent teeth 126.

The coils 124 may be pre-formed and are attached to the teeth 126, or they may be formed by winding wire on the teeth. In pre-forming the coils 124, the coils 124 are pressed to maximize copper density. Each coil 124 may have the two lead wires 137 exiting from the lower edge of the face parallel to the air gap. The coils 124 are pre-formed or wound so the lead wires 137 of each coil 124 exit on the edge facing the yoke 128. The coils 124 may be connected in a wye or delta configuration and parallel or serial configurations. Interconnections between coils 124 are routed through the space around the yoke 128, and soldered connections are tucked into the space between neighboring coils 124. The teeth 126 with their respective coils 124 are assembled to the yoke 128.

To minimize overall stator volume, the interconnecting wires may be routed around the stator 110 in the ring-shaped volume defined by the outer surface of the yoke 128, bottom surfaces of the coils 124, and the inside surface of the housing 122. The space between neighboring coils 124 at the outside diameter may be used to locate joints (for example, soldered joints) between interconnecting wires. Alternatively, the coils 124 may be wound together with no joints. Spaces between coils may also be used to accommodate bosses in the housing 122. The threaded mounting holes may be located in the bosses.

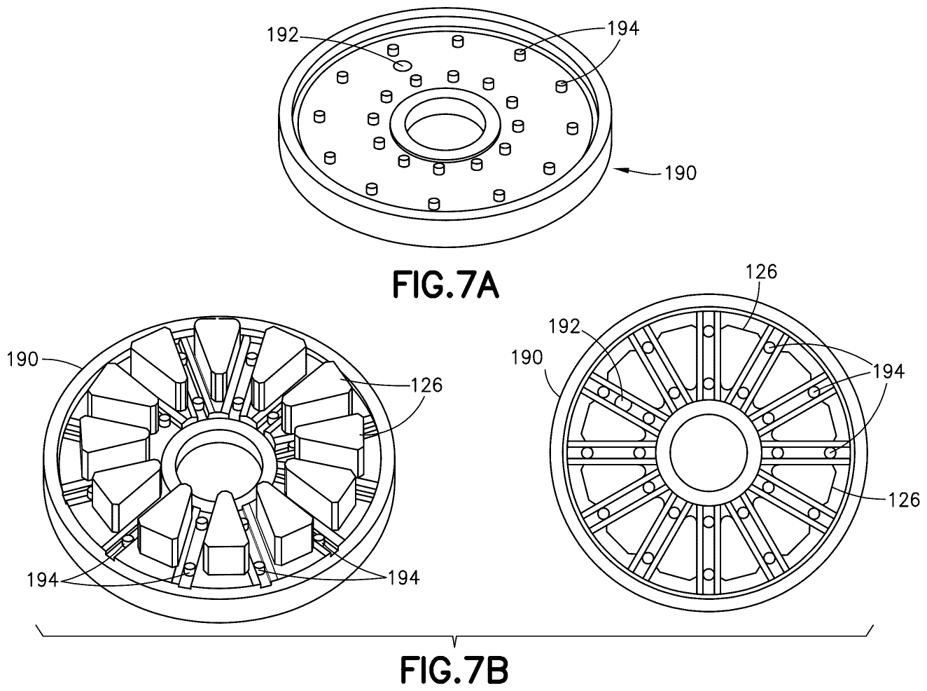

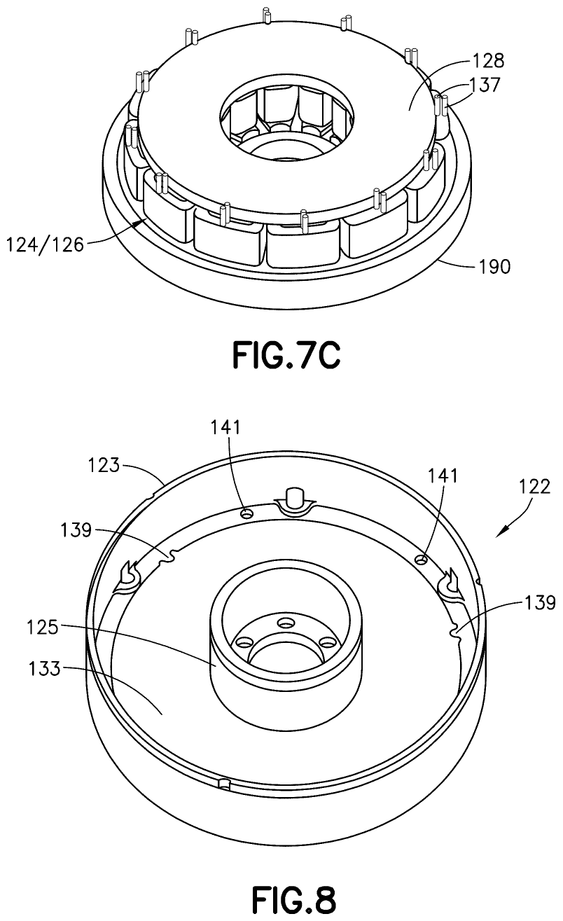

Referring to FIG. 7A, the fixture plate 190 may be used to facilitate the locating of the teeth 126. As shown in FIG. 7B, the features 194 on the fixture plate 190 are positioned between the teeth 126. As shown in FIG. 7C, the yoke 128 is mounted on the teeth 126 on the side opposite the fixture plate 190 with the coil lead wires 137 extending on the side of the yoke 128.

Referring to FIG. 8, the housing 122 is shown. The fixture plate 190, in combination with the housing 122, forms an enclosure that is filled with an epoxy-based potting compound and allowed to cure.

The housing 122 includes an outside wall 123, an inside wall 125, and an end face 133. When the stator is assembled, the inside wall 125 and the outside wall 123 are in close proximity to the coil end turns, enabling a short heat transfer path from the coils 124 to the housing 122 both at the inner and outer radii. The end face 133 may also include mounting features 141, in the form of threaded holes. The housing 122 also has holes 139 for the lead wires 137 to exit. The lead wires 137 may be in the end face, outer face, or inner face.

The stator assembly comprising the yoke 128, the teeth 126 with their respective coils 124, and interconnecting wires are encapsulated in the epoxy-based potting compound. The encapsulating compound provides the desired structural integrity to the stator assembly, in addition to preventing coil vibration during motor operation, and facilitates thermal management of the motor.

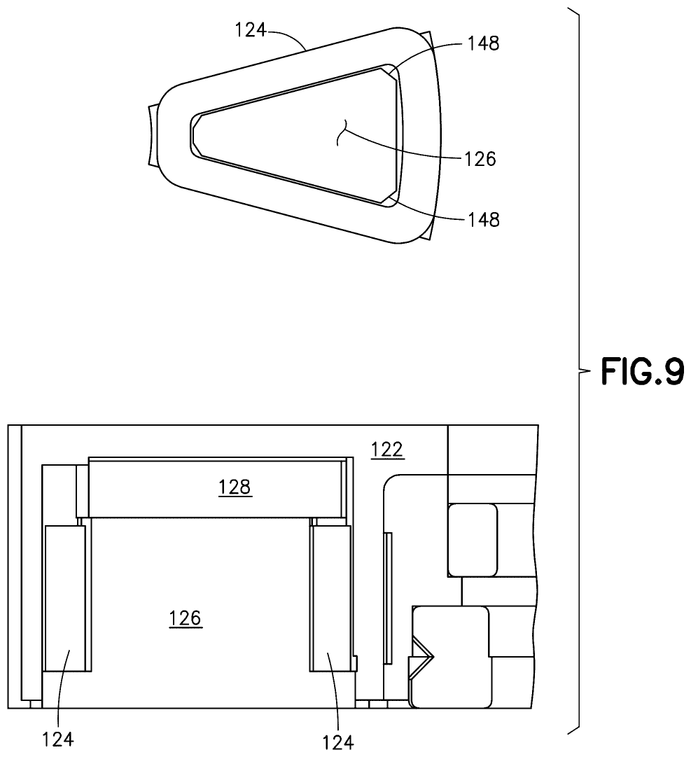

Referring to FIG. 9, one example of encapsulating the stator assembly comprising the stator teeth 126, the yoke 128, the coils 124, and interconnecting wires in an epoxy-based potting compound is shown. The encapsulating compound provides the required structural integrity to the stator assembly, in addition to preventing coil vibration during motor operation, and facilitates thermal management of the motor 100. To ensure adequate adhesion between the coils 124 and the stator teeth 126, between the coils 124 and the housing 122, between the coils 124 and the yoke 128, and between the yoke 128 and the housing 122, the design incorporates nominal clearances between surfaces to ensure a layer of epoxy fill between the surfaces.

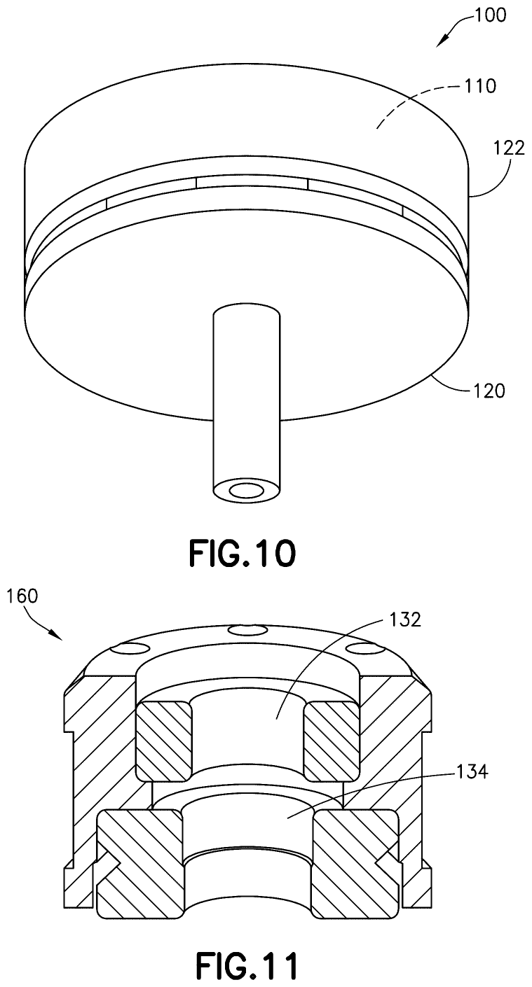

The fixture plate is removed after the potting compound has cured. The housing 122 remains bonded in place to the stator assembly. In FIG. 10, the assembled motor 100 is shown with the stator 110 in the housing 120 and the rotor 120 extending from an end opposite the housing 122.

The stator assembly may also be encapsulated without the housing 122 and may be subsequently assembled onto the housing 122.

Referring now to FIG. 11, one example of a stator bearing sleeve assembly is shown at 160. The motor is characterized by a high axial attractive force between the rotor 120 and the stator 110. The axial force is destabilizing in the sense that it increases with a decrease in gap. The axial attraction also causes a destabilizing moment between the rotor 120 and the stator 110 due to the difference in rotor-to-stator attractive force on either side of the tilt axis. The axial loading is sustained by the thrust bearing 134 located in the cylindrical space inside the stator 110. The radial bearing 132 may also be present to take radial loading. The magnetic attraction serves as a fixed pre-load on the thrust bearing 134. The thrust bearing 134, in combination with the radial bearing 132, provides a restoring moment and a stabilizing moment stiffness between the rotor 120 and the stator 110. The resulting rotor-stator-bearing assembly can operate as a self-contained motor without the need for an external set of bearings. The axial thrust bearing 134 has an axial load capacity of 1800 N, adequate to withstand the internal loading, and a bi-directional axial stiffness of 100 kN/mm. In addition, the thrust bearing 134, in combination with the radial bearing 132, also provides a stabilizing moment stiffness estimated at 1.75 Nm/milli-rad, adequate to counter the destabilizing moment on the rotor 120 due to magnetic attraction, estimated at 0.2 Nm/milli-rad.

The resulting rotor-stator-bearing assembly can operate as a self-contained motor without the need for an external set of bearings.

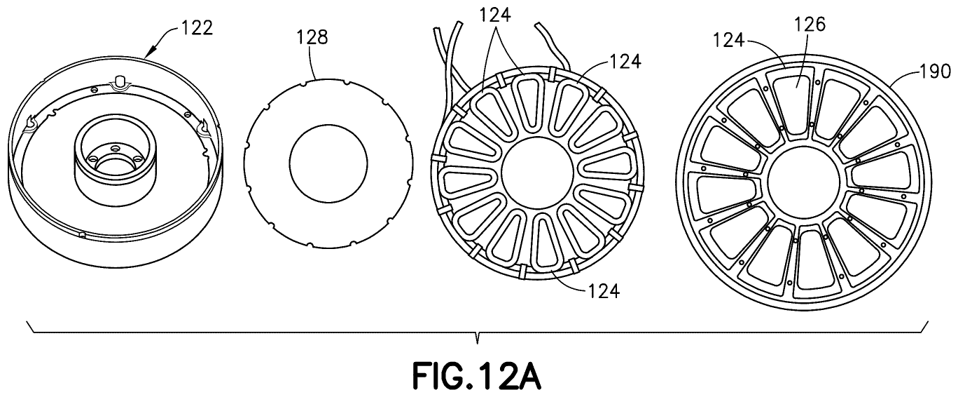

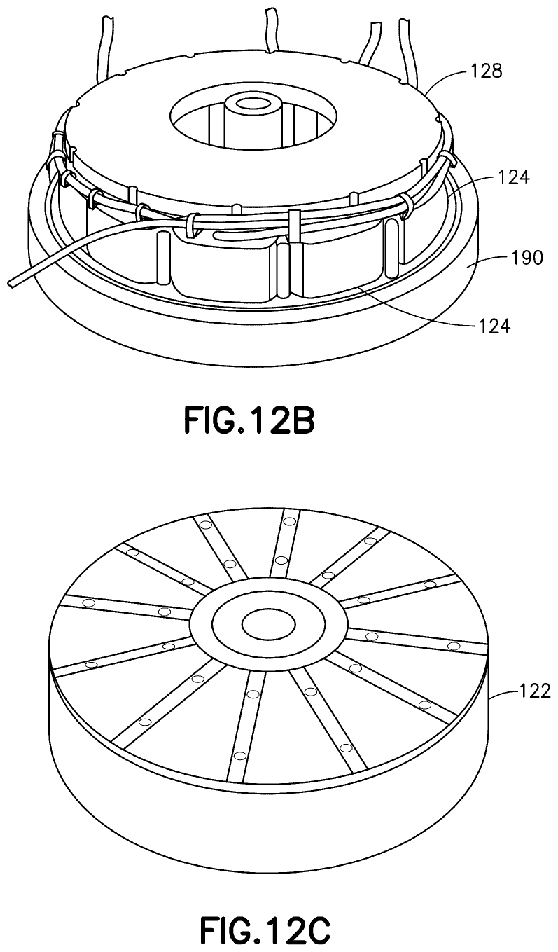

Referring to FIGS. 12A, 12B, and 12C, the stator is shown at various stages of fabrication. In FIG. 12A, the stator in its unassembled form is shown to illustrate the various elements thereof (housing 122, yoke 128, assembly of coils 124, and assembly of teeth 126 on the fixture plate 190). In FIG. 12B, the stator assembly including the coils 124, interconnecting wires, and the yoke 128 on the fixture plate 190 is shown. In FIG. 12C, the encapsulated stator and bearing assembly after the removal of the locating fixture plate is shown.

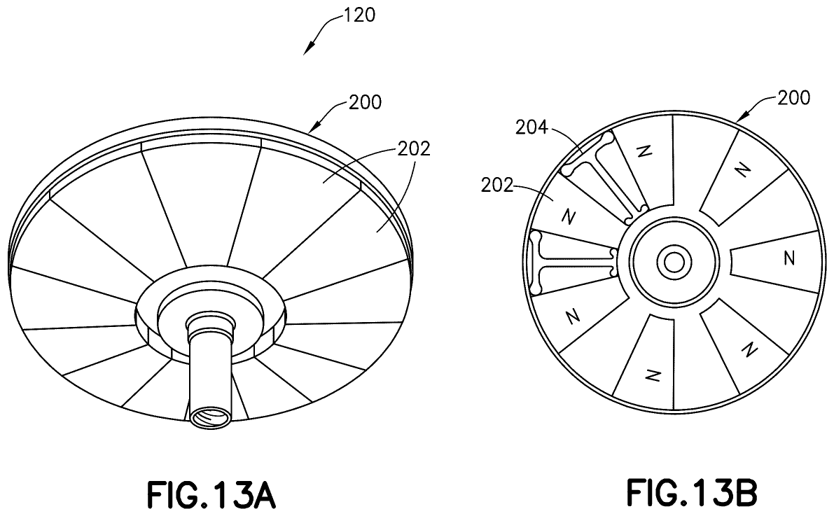

Referring to FIGS. 13A and 13B, the rotor 120 may comprise a rotor yoke 200 and magnets 202. The rotor yoke 200 may include ribs 204 for locating magnets in a circular pattern and a lip to provide required centripetal force for magnet retention. In the single-sided and dual rotor designs, the magnets are surface mounted to the rotor 120. In the dual stator design, the rotor yoke 200 is not present. The magnets are held in place by a non-magnetic structure.

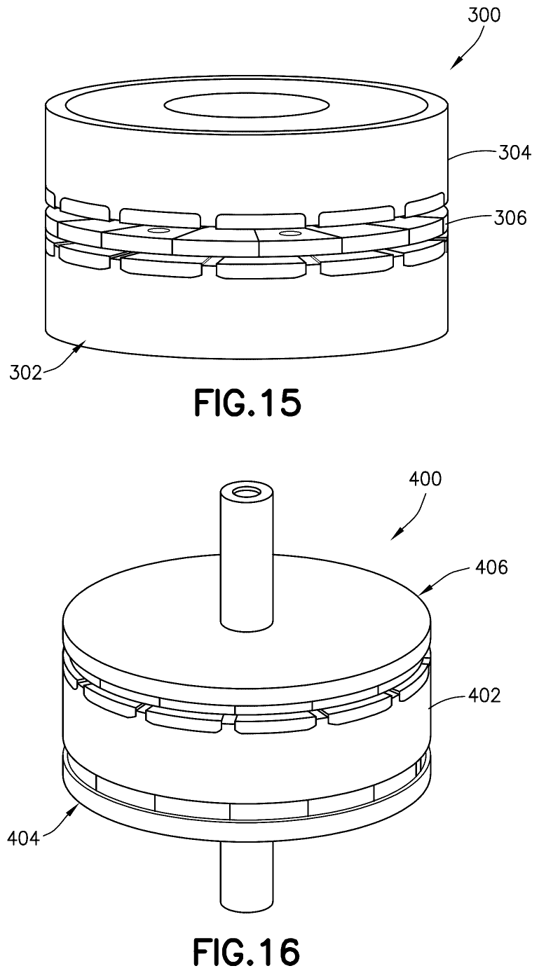

Referring to FIGS. 15 and 16, alternate configurations of stator/rotor assemblies for the motor are shown. As shown in FIG. 15, a motor may comprise a dual stator embodiment 300, where a first stator 302 and a second stator 304 sandwich a center rotor 306. The motor using the dual stator embodiment 300 may be fabricated using the example procedures described herein. As shown in FIG. 16, a motor may comprise a dual rotor embodiment 400, where a single stator 402 is sandwiched between a first rotor 404 and a second rotor 406. The motor using the dual rotor embodiment 400 may also be fabricated using the example procedures described herein. The example dual stator embodiment 300 shown in FIG. 15 and the example dual rotor embodiment 400 shown in FIG. 16 have no internal axial forces and can be assembled without a thrust bearing, using, e.g., only two radial bearings.

As a way of extending the invention, in the example shown in FIG. 2, the stator housing may be potted in place and not removable. However, it is possible to fabricate the stator with a removable housing enclosure. A dual stator embodiment, where two stators sandwich a center rotor (FIG. 15), can also be utilized and fabricated using the procedure described above. In addition, a dual rotor embodiment with a single stator sandwiched between (FIG. 16) can also be utilized and fabricated using the procedure described above. The example embodiments shown in FIG. 15 and in FIG. 16 may not have high internal axial forces and can be assembled without a thrust bearing, using, for example, just two radial bearings.

To summarize one example of a method of fabricating the motor 100:

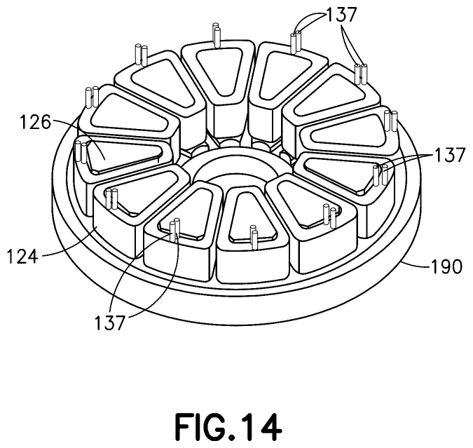

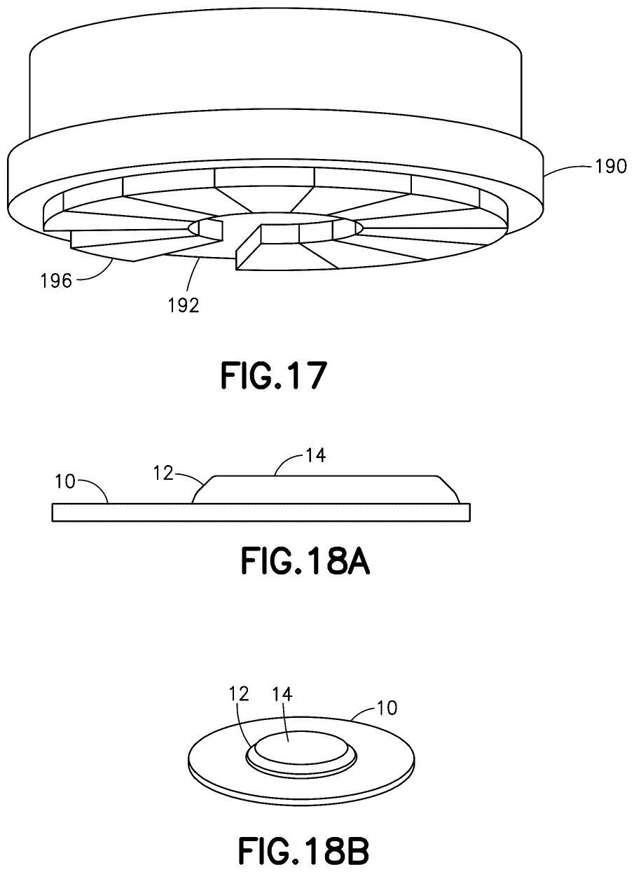

In fabricating the stator:
1. The stator yoke 128 and tooth ring 138 are spray-formed in a near-net manner.
2. The tooth ring 138 is cut into multiple teeth (twelve teeth in this particular example). The yoke 128 is used as is.
3. The main section of each stator tooth 126 is wrapped with a porous electrical insulation tape to prevent direct contact with the coils 124.
4. Using the locating fixture plate 190 as shown in FIG. 7A, the stator teeth 126 are arranged in a circular pattern in their precise locations, as shown in FIG. 7B. The locating fixture plate 190 has features 194 to precisely space the stator teeth 126. As shown in FIG. 7B, the inlet port 192 on the locating fixture plate 190 is aligned in the space between neighboring stator teeth 126 to facilitate epoxy flow through.
5. Each coil is coated with a thin layer of epoxy to cover surface insulation defects.
6. Referring to FIG. 14, the coils are wound or inserted onto respective stator teeth 126 with the lead wires 137 facing away from the locating plate 190.
7. Referring to FIG. 7C, the yoke 128 is placed on the stator teeth 126. The yoke 128 has locating features in the form of flats or notches to precisely orient the yoke 128 with respect to the housing 122.
8. Referring to FIG. 12B, the coils are connected to each other in wye/delta and series/parallel configurations as specified by the motor design. The interconnecting wires are electrically insulated and routed along the periphery of the yoke 128 in the ring-shaped volume defined by the outer surface of yoke 128, the surface of the coils 124, and the housing 122.
9. A temperature sensing device such as a thermistor bulb 135 may be placed between neighboring coils.
10. The housing 122 is inserted onto the assembly, and the lead wires 137 are routed through wire exit holes on the housing 122.
11. To account for tolerances, there may be a clearance between the yoke 128 and the stator housing 122. As shown in FIG. 17, during assembly, magnets 196 may be temporarily placed under the fixture plate 190 to create an attractive force on the yoke 128, and to force the yoke 128 to make contact with the stator teeth 126.
12. Referring to FIG. 12A, the housing 122, the yoke 128, the coil assembly, and the tooth assembly on the locating fixture plate 190 are shown. The housing 122 and the locating fixture plate 190 together can form the encapsulation enclosure. The locating fixture plate 190 has one or more openings that serve as resin inlet ports. The housing 122 has one or more openings that serve as resin outlet ports.
13. The housing 122 may be replaced by a special purpose removable encapsulation mold. In this scenario, the mold is sprayed with mold release to form a non-stick layer.
14. The stator assembly is held with the locating fixture plate 190 at the bottom and resin is injected into the inlet port from below and allowed to rise up against gravity until the resin exits through the exit ports on the housing 122 at the top.
15. The resin is heated to a temperature above the glass transition temperature or to a set temperature to lower viscosity of the resin to allow the resin to flow with low viscosity and fill the space between teeth, coils, yoke 128, and housing 122.
16. The stator assembly including the coils, interconnecting wires, and yoke 128 on the locating fixture plate 190 are shown in FIG. 12B. One example of a finished encapsulated stator is shown in FIG. 12C.

In assembling the rotor 120:
1. The magnets 202 are surface mounted on the rotor yoke 200.
2. Special alignment fixtures or ribs 204 may be used to ensure equal spacing between the magnets 202.

Referring back to FIGS. 1 and 2, in a final assembling of the motor 100:
1. The bearing sleeve 131 is inserted from the lead wire side.
2. The axial thrust bearing 134 is assembled to the bearing sleeve 131 from the air gap side.
3. The radial bearing 132 is assembled from the lead wire end of the stator 110.
4. The rotor 120 is inserted from the air gap end of the stator 110.
5. A retaining clip is inserted from the lead wire end.
6. The insertion of the rotor 120 is carried out using an insertion device that allows gradual controlled insertion of the rotor 120 into the stator 110. This is due to the high attractive force between the stator 110 and the rotor 120 which increases with insertion depth. Upon completion of insertion, the rotor 120 is released from the insertion device.

Although the above example embodiments and methods utilize components produced via spray-forming in a near-net-shape manner, the components may be obtained by machining (or using any other suitable process) of bulk spray-formed material, or they can be made with any other suitable soft-magnetic composite material using any suitable fabrication method.

In producing the components in a near-net manner, particularly with regard to the yoke and the tooth ring, techniques and apparatuses are employed to enable spray deposition of the isotropic soft magnetic composite materials to produce components in near-net form, the composite materials comprising a dense matrix of ferro-magnetic domains separated by electrically insulating boundaries. This composite structure provides a high magnetic permeability while simultaneously ensuring low eddy current loss by breaking up conductive pathways. Soft-magnetic composite materials may provide improved function and advantages over stacked lamination stator cores because the magnetic flux can flow in any direction, thus enabling soft-magnetic composite materials to be suited for stator cores of high-power density electric motors (for example, axial flux motors). Such soft-magnetic composite materials may be used in the fabrication of electric motors that use three-dimensional flux flow, which may be referred to as hybrid-field motors. The term “near-net” means that only the spray-facing surface is post-finished. Surfaces defined by the mold walls and build plate do not need post-finishing or post-machining. The amount of material to be removed through post-finishing is approximately 1 millimeter (mm) or less. As a percentage of the material removal, thicker components have a lower percentage of material removal. Fabrication of stators and stator components having various geometries in near-net form may eliminate the need for expensive, complicated, and time-consuming post-machining operations. Fabrication of stators and stator components such as yokes having various geometries in near-net form may eliminate the need for expensive, complicated, and time-consuming post-machining operations.

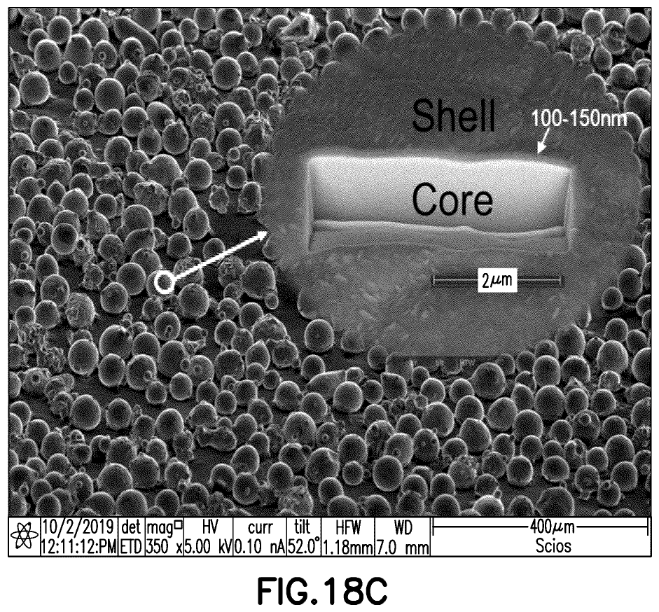

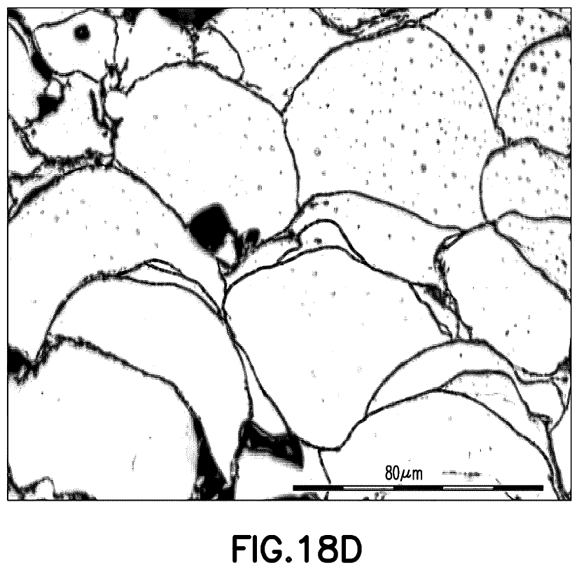

Spray-forming (also referred to as spray-deposition) involves depositing particles at high temperatures and speeds onto a base plate to produce a soft-magnetic composite material. Spray-forming directly onto a build plate 10 results in material geometry with tapered edges 12, as shown in FIGS. 18A and 18B, such that the deposited material 14 may need to be post-machined to a final desired geometry. To avoid post-machining, which is expensive and time-consuming, it is desirable to produce the desired shapes in a near-net manner. Examples of desired shapes include, but are not restricted to, disks, rings, and rectangular shaped parts.

In a spray-forming process, the soft-magnetic composite material may be produced from powder comprising particles each having a core-shell structure, as shown in FIG. 18C. The core may be primarily ferro-magnetic and comprising iron, cobalt, or nickel. The core is enclosed in a shell, which consists of a ceramic insulating material. The shell is reactively formed with material already contained in the core to ensure the structure is mechanically robust. The resulting core-shell particles range from 50 μm to 100 μm in average diameter and have insulating shells that are 100 nanometers (nm) to 150 nm in average thickness.

The resulting core-shell particles form a powder that is converted into a solid material to make the stator core or other components as described herein. This may be accomplished using a spray-deposition system such as the HVAF or HFOV system, as described herein. In either system, the particles are heated to temperatures sufficient to soften the magnetic core and deposits the particles at speeds sufficient to cause the particles to bind together to form the composite material. As shown in FIG. 18D, the micro-structured domains of the material are mechanically interlocked and held together in a compression resulting in higher tensile strength than conventionally produced soft-magnetic composite materials. The spray-formed solid maintains the core-shell structure despite the high velocity impact of the particles on each other.

In some methods of spray-forming, the material may be built up layer-by-layer, each layer being referred to as a spray pass, by controlling the position of the thermal spray gun and rasterization onto a build plate using a rasterization pattern. In other methods of spray-forming, the material may be sprayed from a radially translating position of the thermal spray gun onto a spinning build plate. The particle temperatures and heat of combustion from the spray system causes the temperature of the build plate and previously-deposited material to increase. Temperature regulation is used to minimize fracturing of the insulating shell and to achieve consistent material properties independent of the shape and size of deposited material. Use of external cooling, axisymmetric spray paths, process monitoring, and process control are used to ensure material temperature is maintained within desirable limits.

In one example, magnetic and structural properties of the spray-formed soft-magnetic composite material parts were measured. Table 1 illustrates example properties of the soft-magnetic composite material.

TABLE 1
Soft-magnetic composite material properties

| Material | Measurement | Testing | | |
|---|---|---|---|---|
| Property | Details | Standard | Result | |
| Density | | | 6280 | kg/m³ |
| Permeability | (1/{u₀}) (dB/dH) | | 878 | |
| | at 0 T | | | |
| Saturation | Bₛₐₜ at H = 40 | | 1.65 | T |
| flux density | kA/m | | | |
| Hysteresis | Per cycle | ASTM A314 | 886 | J/m³ |
| loss | | | | |
| Core loss | 1 T, 400 Hz | ASTM A927 | 83.6 | W/kg |
| Transverse | | ASTM B528 | 140 | MPa |
| rupture | | | | |
| strength | | | | |
| Ultimate | | ASTM E8/E8M | 20 | MPa |
| tensile | | | | |
| strength | | | | |
| Thermal | 300 degrees C | ASTM E1416-13 | 11 | W/m-k |

conductivity

It may be noted that for comparable particles sizes of 75 μm, the magnetic properties of a commercially available soft-magnetic composite material are within a measurement error of +/−3% of the spray-formed parts. However, a transverse rupture strength and tensile strength of the spray-formed material are 400% and 200% higher, respectively. The increased material strength allows the spray-formed parts to maintain their shape and dimensions through machining and post-processing steps, which overcomes a common limitation for sintered materials.

The example embodiments described herein achieve fabrication of spray-formed parts (such as stator components such as yokes, tooth rings, housings, and the like) in a near-net manner through the use of molds. In order to achieve the fabrication of such parts:
1. Spray deposited material completely fills a mold cavity. A 100% fill of the mold cavity (no voids) is desired.
2. The mold design should allow for at least one open face through which the material can be spray-deposited.
3. After deposition, the filled material may be released from the mold in a manner that allows the mold to be reused.

The following aspects of near-net shape fabrication using molds are described herein:
(a) design of mold geometry;
(b) selection of mold material;
(c) material deposition into a mold cavity; and
(d) methods to release, separate, and reuse the molds.

The example embodiments described herein, in practice, involve the deposition of powder with a core-shell structure via a high velocity air fuel (HVAF) thermal spray gun. Such powders may be, for example, iron or soft iron alloy, such as iron-base alloy, iron-cobalt alloy, nickel-iron alloy, silicon iron alloy, iron-aluminide, ferritic stainless steel, or similar type alloy, coated with electrically insulating material preferably comprising at least one ceramic-based material, such as alumina, magnesia, zirconia, or the like. The methods described herein may apply to other types of powders as well and may be used with other types of delivery systems. The deposition process involves the following:
(a) A series of repeating scanning motion of the point of incidence of the particle beam on the deposited material. This repeating scanning motion is also referred to as a spray pass.
(b) Variation of angle of inclination of the particle beam with respect to the deposited material.
(c) Measure and monitoring of thickness of the deposited material.

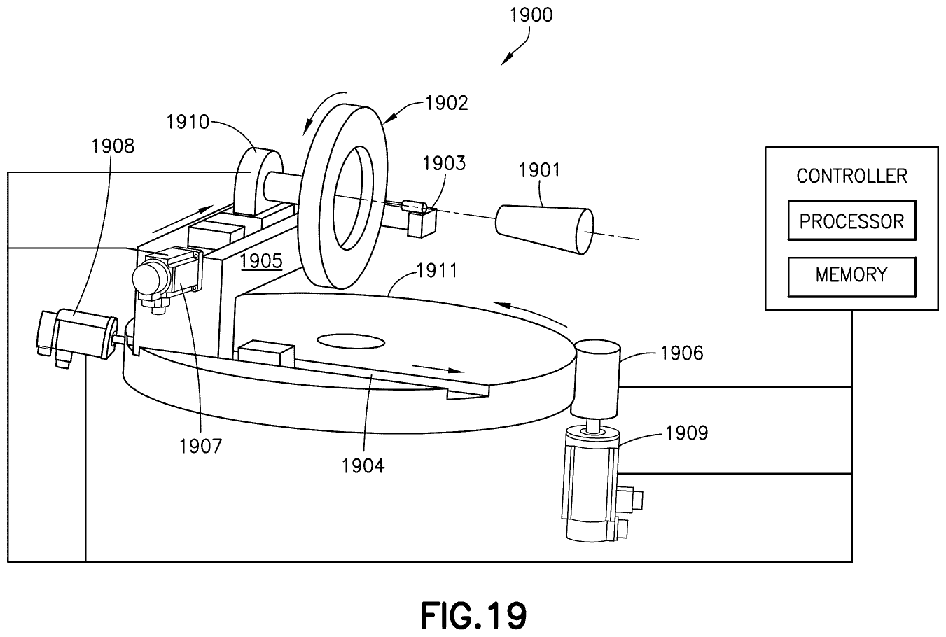

Referring to FIG. 19, one example of an apparatus for depositing such materials is shown at 1900 and is hereinafter referred to as “spray apparatus 1900.” Spray apparatus 1900 is used to create axi-symmetric near-net shaped parts, the spray-formed material being produced in bulk form on a build plate and subsequently cut or otherwise formed to a final geometry through post-machining processes such as electrical discharge machining. However, such machining processes may be time-consuming, thereby leading to higher production costs. The spray apparatus 1900 comprises a spray gun 1901 having a nozzle, a build plate having a mold 1902 attached thereto, and a cooling device 1903. The build plate and the mold 1902 are mounted on a stage 1911 and are rotatable about a Φ-axis of rotation. At least one of the spray gun 1901 and the mold 1902 are movable about three independent axes. The spray gun 1901 deposits the metal powder onto the mold 1902. The cooling device 1903 is located at a fixed position relative to the mold 1902. The movement of the mold 1902 is carried out using an X-direction motor 1907 to drive an X-slide 1905 while simultaneously rotating the build plate and mold 1902 about the Φ-axis of rotation with a motor 1910. A solid material is formed by spraying material from the spray gun 1901 in repetitive passes until a desired thickness has been reached. Following each pass, the distance from the spray gun 1901 to the deposited material interface can be held constant by translating the mold 1902 in the Y-direction on a Y-slide 1904 by driving a Y-direction motor 1908. To spray into the mold cavity corners, a θ-axis can be rotated with the e-direction motor 1909. During the deposition process, the X and Y stage positions are adjusted to ensure the point of incidence of the particle beam on the part surface coinciding with the theta axis of rotation.

Movements and positions of the spray gun 1901 and/or the mold 1902 may be controlled by a controller having at least one processor and at least one non-transitory memory storing instructions, that when carried out by the processor, cause operations that effect the movement of the spray gun 1901 and/or the mold 1902. Movement of either or both the spray gun 1901 or the mold 1902 may be carried out by controlled operations of the motors. The cooling device 1903 may also be controlled using the processor, memory, and instructions.

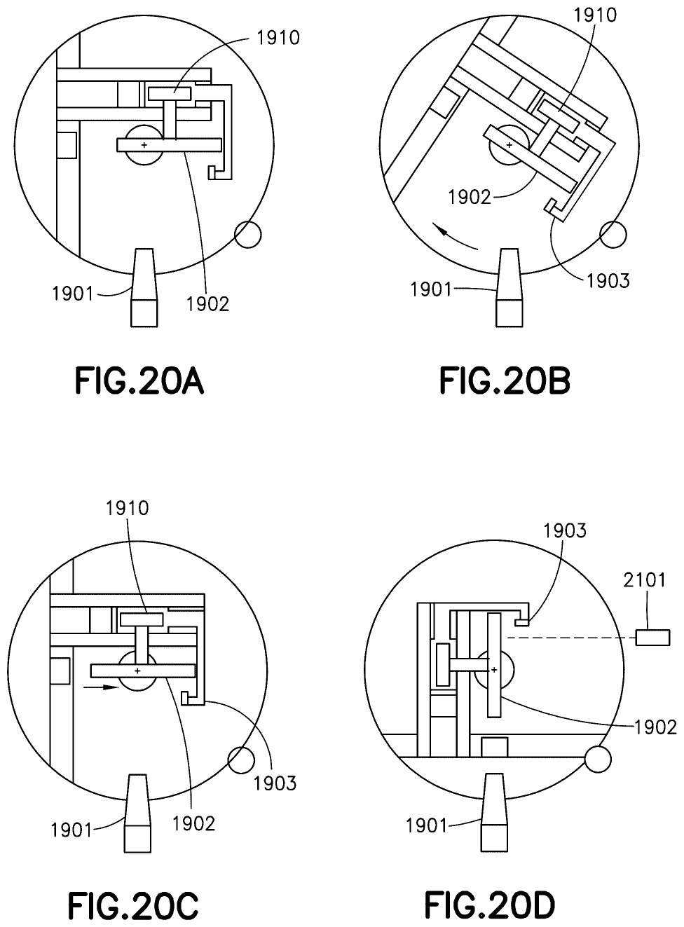

Referring now to FIGS. 20A, 20B, 20C, and 20D, top views of the spray apparatus 1900 are shown at different theta positions. The point of incidence of the particle beam on the part surface is on the axis of rotation of the theta stage. To fill corners without introducing voids, the build plate and the mold 1902 are rotated around the θ-axis as shown in FIG. 20B. Translating the X-position as shown in FIG. 20C continuously exposes a new position on the mold 1902 to the particle beam. When not filling mold corners, the e-rotation is set to zero degrees (normal to spray path) to maximize the material adhesion. Throughout the entire spray operation, the build plate is spinning (Φ-axis 1910) to maintain a uniformly axisymmetric part. The spin also enables uniformity in cooling using an air-cooling fixture 1903 which maintains a constant position regardless of the X, Y, or e-rotation. The deposited material thickness can be measured using a distance sensor 2101 zeroed at the build plate face. The Y-slide plate 1904 is rotated, set at 90 degrees as shown, until the build plate and mold 1902 are facing the distance sensor. Following the thickness measurement the device rotates back to the initial setup, as shown in FIG. 20A, for subsequent material deposition.

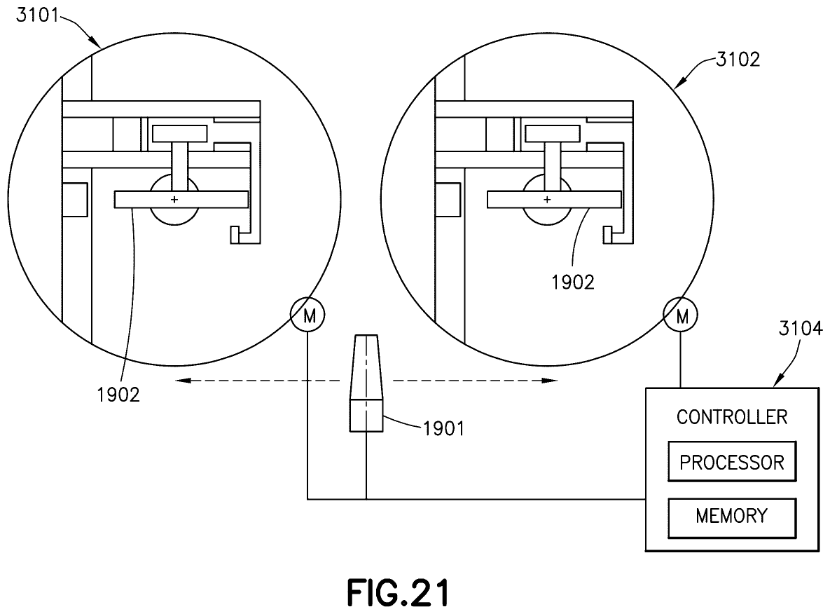

Referring now to FIG. 21, a multiple station setup is shown. A single spray gun 1901 can produce multiple near-net shaped components with parallel stations. A first station 3101 is side by side with a second station 3102. However, it is possible to increase the number of stations to three or more. The spray gun 1901 translates from station 3101 to station 3102 to fill the mold(s) 1902 in a sequential manner. Computer-based control monitors and adjusts the temperature, material thickness, motion trajectory, and run status to ensure repeatability and quality metrics. The computer-based control is shown at 3104 and may include at least one processor and at least one non-transitory memory storing instructions that, when executed with the at least one processor, carry out spraying and movement operations. Movement operations may be carried out by control of the motors M.

An alternate apparatus may be employed in which the mold 1902 spins about a stationary axis and the spray gun 1901 moves to accomplish the desired spray beam translation and inclination. One example implementation is to mount the spray gun 1901 to a multi-axis robot. The robot enables simultaneous scanning and tilt, as well as motion towards or away from the mold 1902. In a multi-station setup, the robot also enables motion from one station to the next.

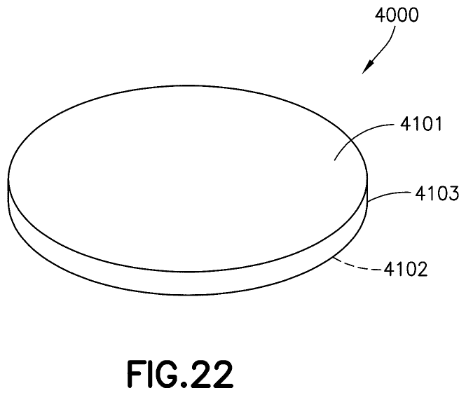

Methods of forming near-net shaped parts involve mold design and filling of molds and are described below. FIGS. 22, 29, 33, 35A, and 35B illustrate examples of final near-net shaped components using the methods described herein.

### Mold Design:

Mold design involves design of mold geometry, selection of mold material, and selection of optimal mold surface characteristics.
(a) Mold geometry: A mold is an assembly of two basic elements: a mold build plate and mold side wall components. The build plate faces the incoming particles from the spray deposition system. The mold side walls define the profile of the desired geometry. For example, to produce a cylindrical ring-shaped part, a mold comprising a build plate and an outside wall may be used. In some embodiments, an inside plug may be used (see FIGS. 30, 31, 32, and 34). The volume defined by the outside wall, the inside wall, and the build plate surface represents the mold volume that is filled.

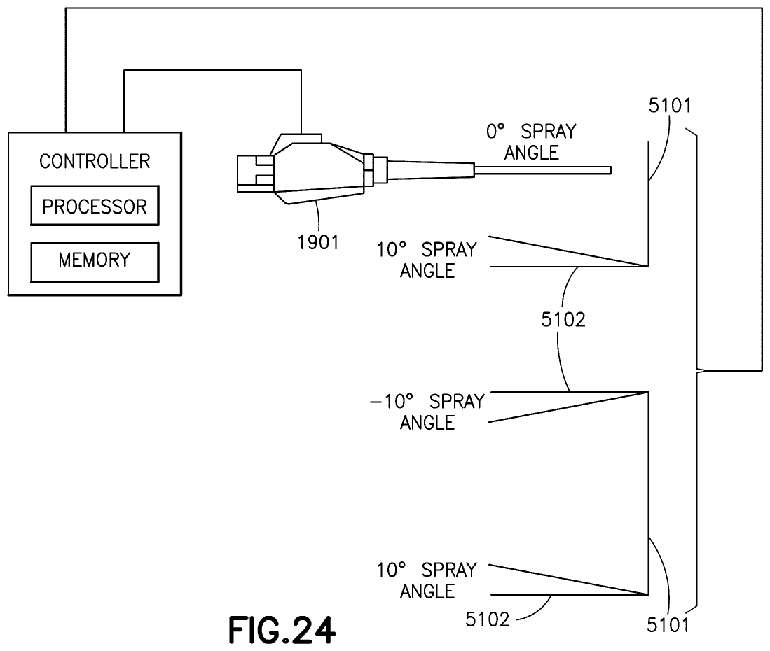

Wedging action of high velocity incident particles result in compressive stresses in the spray-formed material. The compressive stress, in turn, results in a positive contact pressure on the mold wall. The mold wall, if made of a lower strength material such as aluminum, should have adequate thickness to resist the compressive stress.
(b) Mold surface characteristics: To achieve 100% fill of the mold volume, the mold surface should meet two requirements. (i) The mating surfaces need a high degree of flatness to avoid gaps between surfaces. Gaps between mating surfaces, due to surface roughness, impurities, or scratches may result in voids in the mold fill volume. (ii) The second requirement is the avoidance of edge radii and chamfers. The incident particle beam cannot reach the space under chamfers and radii, resulting in voids. Generally, mold surfaces in contact with each other are machined to a surface flatness of 0.005 inches (in.) or better. Machining practices to avoid edge chamfers and corner radii are adopted in producing the mold. Mold surface may be grit blasted. The desired level of bond strength between material and mold surface can be achieved through grit blasting.
(c) Mold materials: The selection of material for the build plate and side walls is based on multiple criteria. The materials for the mold are selected as follows. The build plate component is low carbon steel, and the mold outer wall is aluminum. The low carbon steel material is selected due to the limited adhesion strength between the deposited material and the steel.
   Build plate: One factor in selection of build plate material is the bond strength between the build plate and the deposited material. A low bond strength is desired to enable release of the mold after deposition. For this reason, the build plate is made of high strength steel. On the other hand, too low a bond strength leads to premature delamination. Bond strength is proportional to the extent of penetration of the high-velocity particles into the mold surface as well as the particle temperature. To limit penetration, the build plate, whose surface directly faces the impinging particles, is made of a high strength material such as steel. On the other hand, grit blasting of the build plate to increase surface roughness leads to higher bond strength.
   Mold wall: In contrast to the build plate, impinging particles meet the mold walls at a shallow angle (FIG. 24) and do not have adequate momentum to penetrate the wall surface. Therefore, mold walls can be made of lower strength materials such as aluminum without the risk of particles penetrating the mold. An advantage of using aluminum is that the thermal expansion difference between aluminum and the sprayed material is great. One approach to releasing the mold wall is to use the difference in thermal expansion to relieve the contact pressure between the mold wall and the spray-formed material. To facilitate this, the mold wall material should have a higher thermal expansion coefficient than the spray-formed material. Since aluminum has a higher thermal expansion coefficient than ferrous materials, aluminum is an ideal material for the mold wall.

### Axisymmetric Near-Net Shaped Disk:

### Deposition in Mold:

The following outlines the near-net shape deposition of a spray-formed disk shaped part 4000, which may be adapted to form a stator or a tooth ring or other component. FIG. 22 details the disk part geometry, which includes two opposing top and bottom faces. The top face is 4101, and the bottom face is 4102, which are separated by a vertical wall 4103 defining a cylindrical outer diameter. The top and bottom faces 4101, 4102 are substantially flat and parallel. Parts of other shapes are possible.

The disk shaped part 4000 cannot be fabricated by spraying directly onto a build plate surface. The deposited materials form a sloped edge wherever the deposition stops. An example of the sloped edge formed on the build plate is shown in FIGS. 18A and 18B.

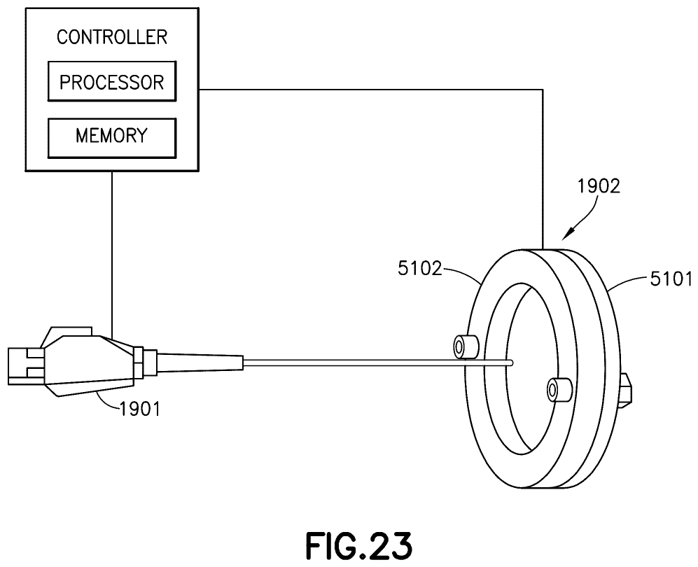

To produce the disk shape, a mold comprising a build plate and an outer wall is assembled on a rotating fixture. The powder spray is aimed into the open face of the mold. At least the spray gun 1901 and movement of the mold may be controlled using a controller having at least one processor and at least one non-transitory memory storing instructions that, when executed with the processor, cause the operations of the spray gun 1901 and movement of the mold (as well as any cooling). A schematic of the disk setup is shown in FIG. 23.

As shown in FIG. 23, an example of the mold 1902 may comprise a build plate 5101 and a mold outer wall 5102. The powder spray beam from the spray gun 1901 deposits material into the mold cavity. To achieve a complete fill, a variable trajectory is used, as shown in FIG. 24.

The mold assembly or mold 1902 comprises multiple parts. The near-net shaped disk mold uses two components. The first, the build plate 5101, made from low carbon steel, is fastened to the mold outer wall component, made from aluminum, as shown in FIG. 23. In one example, these two components are fastened with two or more nut and bolt assemblies, positioned radially uniformly, with axial clamping force, to promote even clamping force around the mold outer wall. The torque of each fastener is set to about 30 lb-ft (pound-feet). The aluminum mold wall is sufficiently thick such that the material does not deform when compressive stress from spray-forming is applied to the mold walls.

Prior to mounting the mold assembly, the components are grit blasted while fastened together with aluminum oxide grit, for example, mesh size 40-140, to aid in adhesion. The mold component material is selected to enable part removal from the mold 1902. The details are explained in further detail in the “removal from mold” section.

Selection of steel material for the build plate component may present an adhesion challenge. To overcome the low adhesion strength between the steel build plate and the deposited material the first layers may be deposited without any cooling to increase adhesion. Up to ten uncooled adhesion passes may be used, the most common being five passes. Directly following the uncooled adhesion passes, a series of passes with a tapered temperature profile may be carried out to deposit material until the continuous process set point is reached. In this example, once the temperature has been tapered to about 190 degrees C., the standard temperature control scheme drives the process.

Referring to FIG. 24, the motion sequence for fabricating the disk shaped part 4000 may be split into two components: (1) The motion of the spray gun 1901; and (2) the motion of the mold 1902. For the motion of the spray gun 1901, a six-axis robot may be employed, such robot being controlled by a controller having at least one processor and at least one non-transitory memory storing instructions, that when carried out by the processor, cause operations of the robot. The robot traverses a linear path parallel to the build plate 5101 and enables changing the spray angle up to, e.g., 45 degrees from the build plate 5101. The angle can be in any orientation relative to zero degrees which corresponds to spraying directly normal to the build plate 5101. The movement of the mold 1902 may also be controlled by the controller, e.g., through control and operations of motors. The spray angles used at the vertical walls are shown in FIG. 24.

As shown in FIG. 24, a desired variation on an angle of incident of particle beam with respect to a mold 1902 to fill inside corners of the mold 1902 is shown. The spray deposition process utilizes precise control of the point of incidence of the particle beam (“beam spot location”) and orientation of the beam with respect to the mold (“beam orientation”). Precise control of the beam spot location and beam orientation is accomplished by mounting the spray gun 1901 to a servo controlled 6-axis robot arm or by fixing the spray gun location and translating/rotating the mold assembly as described with regard to the apparatus 100 of FIG. 19. In addition, the mold 1902 may be mounted on a rotating platform. The beam orientation angle of 2-20 degrees (typically 5-10) is used near the mold walls and 0 degrees at regions away from the mold walls. To produce axisymmetric parts (such as parts with cylindrical surfaces), the mold 1902 is mounted on a platform that rotates about the axis of symmetry, and the beam spot is traversed along a linear radial or close to radial path.

An angle of 5-10 degrees may be used at walls parallel to the path of the spray gun 1901. This angle helps reduce the amount of robot travel or mold travel and enables the best possible adhesion of the sprayed material to the build plate, which is at a maximum when the spray angle is zero degrees. The spray gun 1901 (as well as other spray devices disclosed herein) may be controlled using a controller having at least one processor and at least one non-transitory memory storing instructions that, when executed with the processor, cause the apparatus to perform various operations.

For round parts which have axial symmetry, such as the disk, the mold assembly or mold 1902 is continuously rotated about the axis of symmetry. The robot moves the spray gun 1901 synchronously in a linear path to fully deposit material in the mold cavity. The mold assembly or mold 1902 rotational speed and the linear rotational speed are coupled so the beam spot velocity with respect to the build plate face is fixed at, e.g., 600 mm/s (millimeters per second). Additionally, or alternatively, the mold 1902 may be moved by itself or synchronously with the spray gun 1901, as in the spray apparatus 1900.

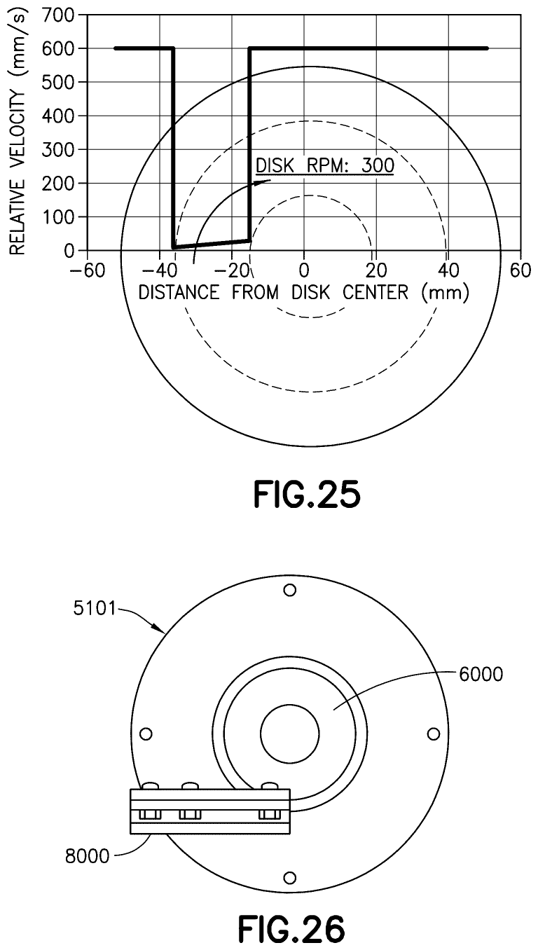

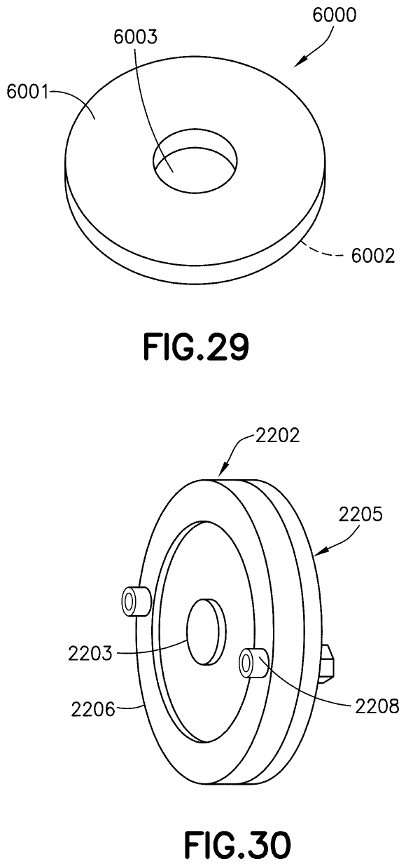

FIG. 25 shows the build plate rotational direction and the translation speeds used. The beam spot velocity may vary by plus or minus fifty percent during the fill operation to optimize the deposited material temperature. FIG. 25 is an example of desired scanning speed of point of incidence of particle beam with respect to mold center to produce a disk shaped part 6000 as shown in FIG. 29. In this example, the disk is spinning at 300 rpm (revolutions per minute) and the desired relative surface speed is 600 mm/s.

In any embodiment, the temperature of the deposited material may be controlled using a computer algorithm that starts each deposition pass once a given temperature has been reached. As an example, a non-contact infrared pyrometer may be utilized to measure the temperature. The mold assembly or mold 1902 may be pre-heated to, e.g., 300-325 degrees C. before the deposition operation starts to ensure the mold temperature is consistent throughout deposition process. The temperature may continually increase during the material deposition process due to the hot particles adding to the material and the combustion reaction flame positioned directly over the mold assembly during deposition. Each deposition pass may begin when the mold assembly has cooled to, e.g., 190 degrees C. to ensure pass-to-pass consistency. To control the maximum temperature of the mold assembly or mold 1902, the robot translation speed may be adjusted to control the deposition time of each pass. The maximum temperature set point may be set to, e.g., 350-400 degrees C.

The mold assembly and deposited material can be cooled with different processes. Two of these processes are described herein. The first process uses the compressed air from the spray gun 1901 to cool the mold assembly. The spray controller stops powder flow and turns off the fuel source. The compressed air source remains on while the robot moves the spray gun 1901 along the same motion path to cool the assembly. This approach may use a significant amount of time to complete a part. The second process utilizes a secondary cooling source. Compressed air jets either from point sources or linear air knife edges are pointed toward the mold assembly. The amount of cooling can be controlled by varying the opening cross section, the air feed pressure, and the distance the air jet is located from the mold assembly. There are a large number of cooling settings that would work. In one example embodiment, the settings used are: 40 psi (pounds per square inch) inlet pressure, ten-foot half inch hose, and a three-inch air knife with a 0.006 inch opening, positioned half an inch below the mold center line and about two inches from the build plate face. The shape and placement relative to the build plate is shown in FIG. 26.

FIG. 26 is directed to an air knife cooling of the deposited material and build plate 5101. This Figure shows the location of an air knife 8000 used to cool the deposited material forming the disk shaped part 6000. The temperature of the mold assembly or mold 1902 and the deposited material reaches up to 450 degrees C. during the spray-forming process. As the temperature rises, the mold wall 5102, made of aluminum, tends to expand more than the deposited material. To prevent separation of the material from the mold 1902 during the deposition process, it is desired to maintain a positive surface contact pressure at the mold walls 5102. To ensure there is adequate contact pressure, the mold 1902 is preheated before beginning deposition of the material. In addition, the mold walls 5102 are bolted to the build plate 5101 with adequate clamping force.

The squareness of the edges and mating faces allows for the achievement of a near-net shaped part without any material exclusions or voids. The flatness of the mating faces connecting the build plate and the outer wall of the mold should be less than 0.005 inch. Any roughness or imperfections in the surface can cause the two faces to have regions where the faces do not touch, which may lead to the formation of voids. The mating faces should remain smooth (roughness less than 0.005 in.) even following grit blasting. Therefore, fastening the mold assembly prior to any processing is desired. In addition to flatness, sharp edges should be formed between the mold assembly parts. A radius or a chamfered edge creates a volume under the mold that cannot be accessed by the deposition process. The material may not properly fill the volume with a radius or chamfer present. A void will form which the spray material will not be able fill.

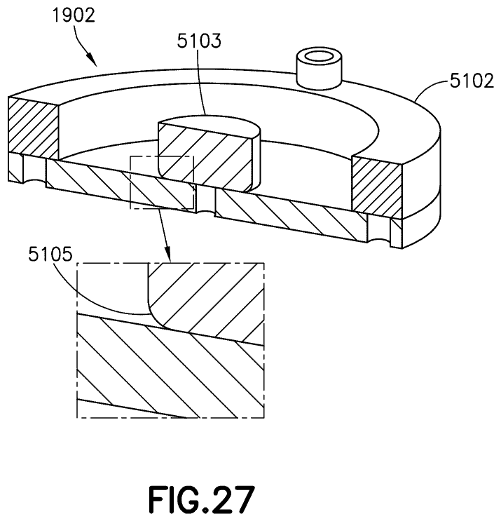

FIG. 27 is an example of radius or chamfer edges that lead to voids. As shown, the outer mold wall 5102 depicts sharp edges and ideal mating surfaces which are preferred for a void free near-net shape. A central mold part 5103, not used for a disk part, is shown with a radius 5105 that causes the spray-formed material to be incomplete when depositing material. When radius or chamfer edges are present a material void may manifest. Voids may also occur when the corners are edge broken. Square or sharp edges are used to achieve a desired spray-formed part. The exact radius tolerable is unknown.

The deposition thickness may be controlled with two different methods. In the first method, sacrificial material may be sprayed to calibrate the deposition rate or material growth per pass. With the deposition rate the number of passes required can be calculated. The second method uses a distance or displacement sensor which may be zeroed on the build plate face prior to deposition and then used to periodically measure the total deposition thickness.

Removal from Mold:

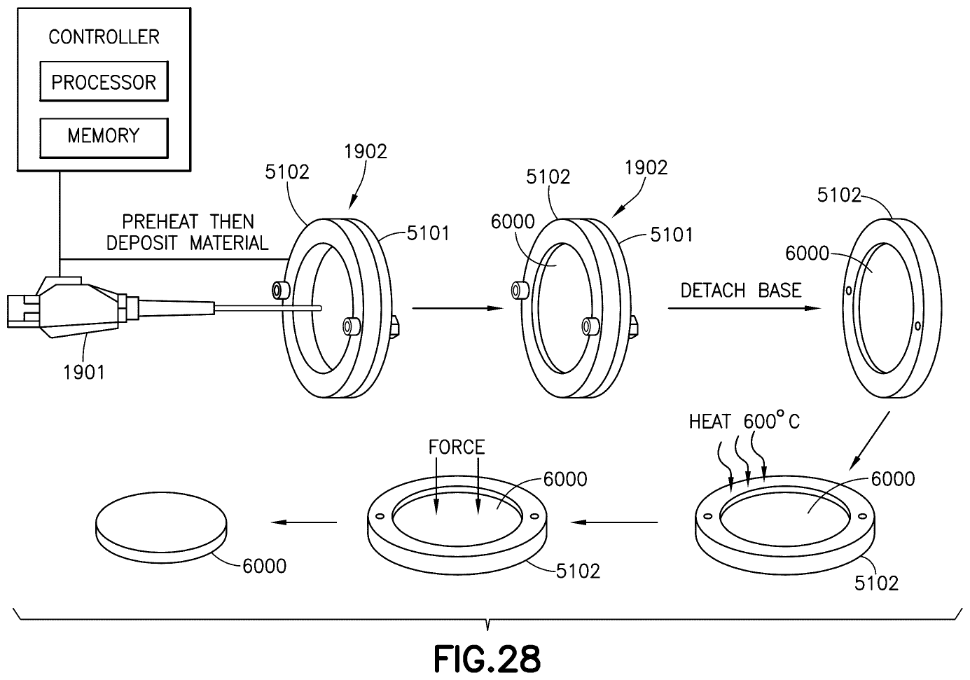

Referring now to FIG. 28, upon completion of the material being deposited in a multi-pass operation using the trajectory described in FIG. 24, the material is removed from the mold 1902. Prior to deposition, the mold assembly of the build plate 5101 and the mold walls 5102 are pre-heated to increase material adhesion and prevent thermal shock from the hot particles. Once a desired part thickness is achieved, the mold walls 5102 and build plate 5101 are removed from the spray apparatus 1900. The build plate 5101 is detached from the mold walls 5102. The part is heated to remove the part from inside the mold walls 5102. The heat causes the mold walls 5102 to expand more than the part due to the difference in thermal expansion between the two materials. Following the heating the part can be removed from the mold 1902.

To remove the build plate component from the mold assembly, a small mechanical force may be applied between the build plate 5101 and the mold wall 5102 interface. This allows the build plate 5101 to detach leaving the other components behind. If the adhesion force holding the sprayed material onto the build plate 5101 is stronger than the strength of the deposited material, then the separation will not occur at the interface but rather within the deposited material fill.

Once the build plate 5101 has been removed, the mold wall 5102 is separated from the spray-formed material. Depositing the material with a thermal spray operation causes the material to be under compressive stress due to the particles wedging into the material during deposition. This stress holds the material tightly inside the aluminum mold. It may be possible to apply a large force with a press and remove the deposited material from the mold 1902; however, doing so may cause the material to facture before the part is released from the mold 1902.

Instead, it is possible to take advantage of the difference in thermal expansion between the material of the mold wall 5102 and the deposited material. Aluminum is generally selected for the mold walls 5102 as the thermal expansion coefficient is roughly double the sprayed material (23.3 μm/m-C versus 12.0 μm/m-C, respectively). Heating the combined mold wall 5102 and the deposition material to 600 degrees C. causes the aluminum to expand more than the deposited material. While the mold 1902 is expanded the deposited material shaped like a disk (e.g., disk shaped part 6000) can be directly removed with little to no force applied, as shown in FIG. 28.

A near-net shape dimensional variation of 0.005 in. or less can be achieved through tight tolerancing of mold dimensions. Lower dimensional variation can be achieved by under sizing the mold 1902 to account for the expansion that occurs when the mold temperature rises during the deposition process. The core-shell material delaminates with nearly no residual deposition on the mold surfaces which allows the molds 1902 to be reused for repeat parts.

Axisymmetric Near-Net Shaped Disk with a Center Hole:

An extension of the near-net disk shape is the same cylindrical shape but with the inclusion of a cylindrical void or a ring with square edges. FIG. 29 shows the desired part geometry of a such the part 6000, which may be a motor component, having a ring-shaped void. The spray-formed motor part 6000 may be a spray-formed disk having a first face 6001, an opposing second face 6002, and a hole 6003 in the center of the disk and extending through the disk from the first face 6001 to the opposing second face 6002. A motor component such as the spray-formed part 6000 may be formed in a near-net manner.

Referring now to FIG. 30, a mold assembly or mold 2202 is similar to the mold 1902 for a disk shaped part 6000 previously described; however, an additional part in the form of a plug or a center mask 2203 is fastened to the build plate 2205. The mold build plate 2205, mold wall 2206, and the mold center plug 2203 are separate and may be different materials. The typical build plate material is low carbon steel, and the mold pieces (e.g., the mold wall 2206) are aluminum. The mold wall 2206 is held to the build plate 2205 with fasteners 2208. To ensure proper tolerance, an alignment jig or indexing pins can be used to assembly the mold wall 2206 to the build plate 2205. The mold assembly is fastened prior to grit blasting the surfaces, as was done previously. Additionally, all previous details regarding flatness and edge sharpness for the center mask 2203 are followed.

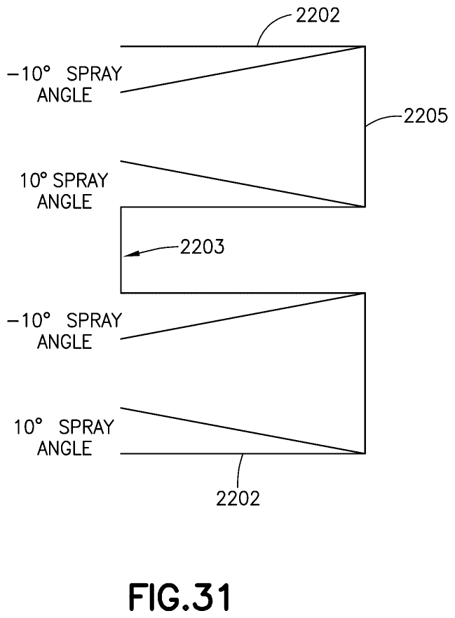

Referring to FIG. 31, in one example method of forming the part 6000, a trajectory change is made with the spray gun path. The addition of the mold center mask 2203 involves an extra angle transition at the wall of the center mask 2203. There may be a minimum distance between the mold outer wall and the mold center plug wall defined by the spot size of the spray beam and the height of the mold. The distance is larger than the sum of the spot size and the tangent of the spray angle times the height. All other spray operations are performed the same as for the disk shaped part.

Still referring to FIG. 31, a desired angle of incidence of the particle beam at various points of incident of the particle beam to adequately fill the inside corners of a mold 2202 with the center mask 2203 is shown. This is an extension to the spray angle outlined with regard to previously-described embodiments. The same or a similar procedure is used for the vertical walls of the plug (center mask 2203) as the inner surfaces of the mold wall 2206. The spray transitions from a negative angle at the mold walls 2206, to a zero degree angle when directly depositing on the build plate 2205, then transitioning to a positive angle when spraying along the walls of the center mask 2203.

The mold removal process is nearly identical to that of the disk without the center mask 2203 except for the following process change. Following the removal of the steel build plate 2205, the center mask 2203 should be removed next. The removal process also takes advantage of the difference in thermal expansion. The material of the center mask 2203 is aluminum. To remove the center mask 2203, the mold and deposition assembly are heated to 600 degrees C. The heated assembly is removed, then selectively cooled at the center mask 2203. The cooling can be achieved using ice, dry ice, liquid nitrogen, or another targeted cooling apparatus. Multiple temperature cycles may be used due to the center mask 2203 cooling conducting heat from the spray material. Once the entire face of the center mask 2203 has been released from the deposition spray, removal should require little force.

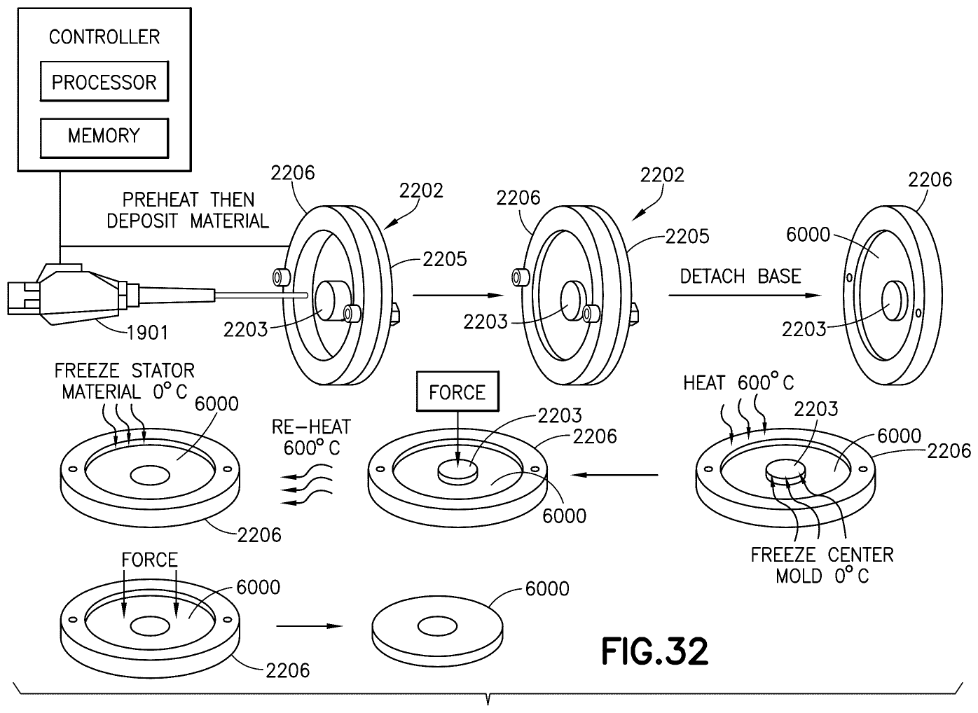

A process flow diagram is shown in FIG. 32. Here, a mold fill and a removal process for a cylinder near-net shaped part, such as part 6000, is shown. This Figure is similar to FIG. 28, with the disk-shaped mold incorporating a center void in the near-net shaped part. The additional procedure to remove the center mask 2203 creating the material void is also outlined. The fill operation proceeds the same as FIG. 28 utilizing the practices outlined in FIG. 31. To remove the center mask 2203, a combination of heating and cooling is used. The entire sample is heated to expand the components, then selective cooling is applied to the center mask 2203 to shrink the size of the center mask 2203. Once the center mask 2203 has shrunk, a force can be applied to press the center mask 2203 from the mold center. The other operations are performed in the same manner as outlined in FIG. 28.

Axisymmetric Near-Net Edge Shape Stepped Disk with a Stepped Center Hole:

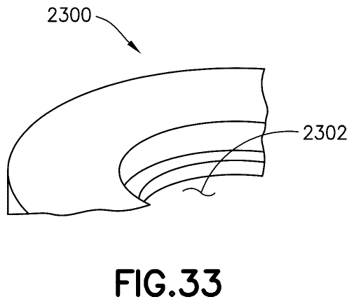

A near-net shaped part 2300 with two different diameters is described with reference to FIG. 33. The shape is similar to the part 6000 with center void. In particular, a stepped edge disk with a stepped center hole 2302 is shown.

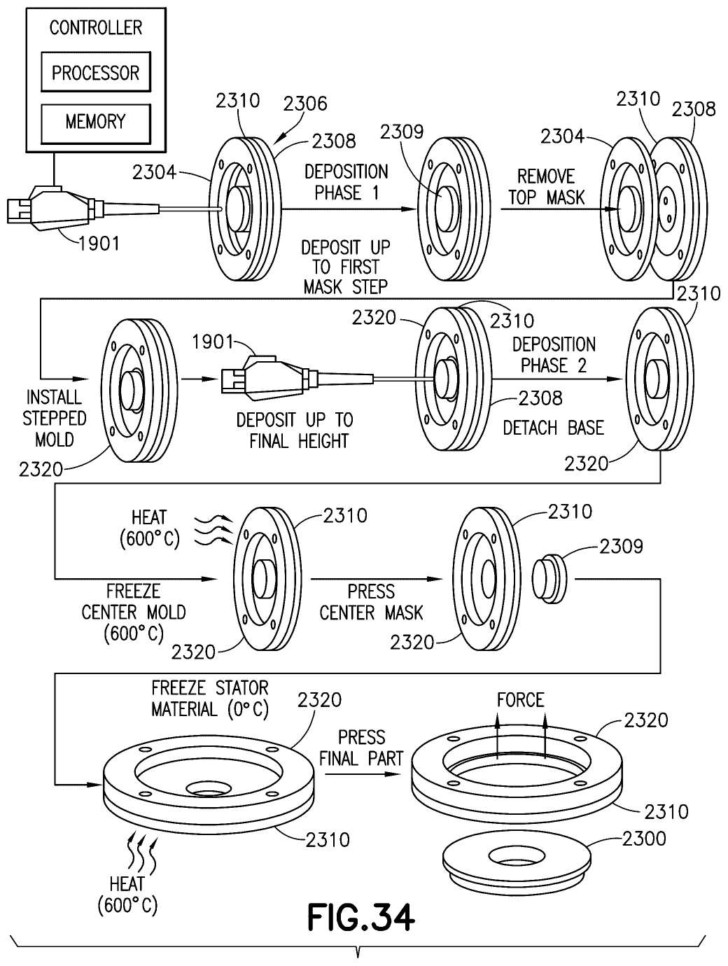

Referring to FIG. 34, a two-phase deposition and the mold removal process for the stepped part 2300 is shown. There is an increased complexity of the near-net part 2300 compared to previous parts. Part 2300 has multiple inner and outer diameters as a function of the part height. Complex part features use a multi-step process utilizing a series of molds. This is a desirable feature for parts with surfaces which transition from parallel to perpendicular with respect to the direction of the incident particle beam. The multi-step process of making part 2300 ensures the build always originates from the initial build plate. A continuous solid is desirable for spray-formed parts using molds. Voids and discontinuities in the deposited material may lead to poor material performance.

In making part 2300, the initial deposition process is similar to the disk with center void described previously. A mold assembly or mold 2306 comprises a build plate 2308 and a mold wall 2310 with a center plug 2309. However, in an example process of making the part 2300, a mask 2304 with the same dimensions of the mold wall 2310 and the center plug 2309 is placed on top of the mold wall 2310 and the center plug 2309. FIG. 34 shows the mold 2306 and mask 2304 in the first row of the process flow diagram. Previously, the mold height was not critical so long as the mold height was greater than the final part height. However, for the stepped mold, the first layer mold height should be the same as the target height for the part feature. The material deposition fills the mold cavity until the material reaches the top of the mold but is below the mask 2304.

Once the material has filled the cavity, the parts of the mask 2304 are removed from the mold 2306 and a second mask 2320 with the stepped larger diameter is installed. The material is filled beginning with the smallest diameter and proceeding to the largest of the larger diameters to ensure continuity. Following the installation of the second mask 2320 the same fill procedure can be used by changing the spray path trajectory positions to match the larger dimensions.

Manufacture of this part involves stoppage mid-deposition to change out the mold components. Following the change of mold components, the mold material is grit blasted. Additionally, when restarting the material deposition process the mold 2306 is reheated using the same procedure as the initial deposition before resuming deposition. However, the adhesion passes are not used for the restarted spray.

The mold removal procedure is nearly identical to the procedure for removing the disk with center void. The primary difference is the mold material has a directional component and can only be removed in one direction. The stepped face prevents the mold from being removed in either direction, as was possible with previous molds.

Additionally, it may be desirable to cool the deposited material to aid in removing the mold outer wall.

### Rectangular Near-Net Shape:

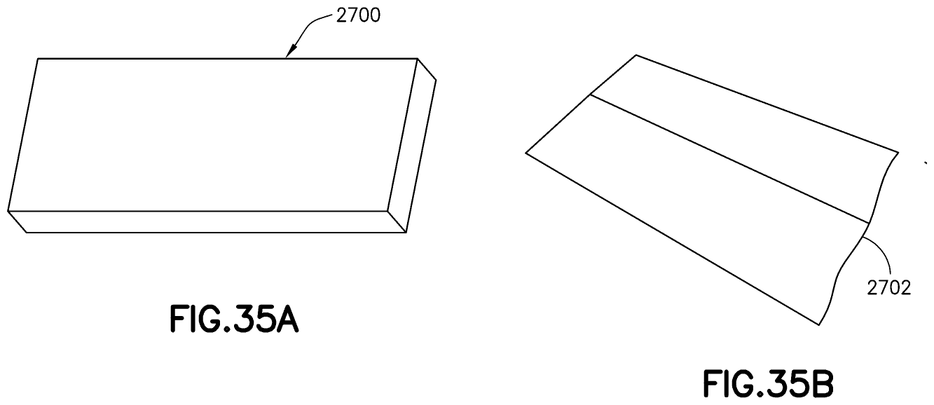

The next section describes the near-net fabrication of a rectangular part 2700 using the spray deposition technique. The goal shape is shown in FIG. 35A. Creating sharp vertical corners with thermal spray may present a challenge. Spraying directly onto a build plate with no mold walls causes the edges of the spray volume be sloped or tapered. An example of the tapered edge 2702 is show in FIG. 35B.

To overcome the edge taper a mold assembly or mold 2802 can be used, similar to the round shapes previously described. There are two different approaches when dealing with straight edged parts. The first is the use of split multi-part molds and the second, described previously, is the use of single part mold for each height change. This section describes the split multi-part mold assembly.

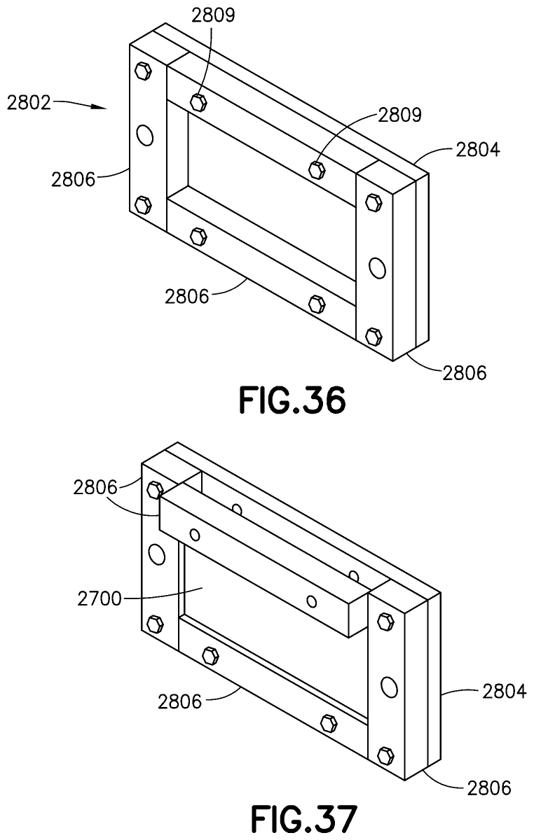

Referring to FIG. 36, a rectangular mold assembly or mold 2802 with multi-part removable mold walls is shown. The split multi-part mold 2802 comprises a single part build plate 2804. The material selected for the build plate 2804 is low carbon steel. Walls 2806 of the mold are built of individual parts for each edge. Since the walls 2806 are not one continuous piece it is possible to select multiple different materials for the walls 2806. LOW carbon steel and aluminum are typically selected.

Each of the walls 2806 is fastened to the build plate 2804 using fasteners 2809 and with proper torquing. If any part moves during the deposition process, the final form may be incorrectly sized. Additionally, any gaps between parts may cause a material void. The faces and edges should have the same flatness and radii control outlined in the near-net shaped disk section.

Once the parts of the mold 2802 are properly fastened, the assembly is grit blasted and mounted on a stationary fixture. To properly deposit material in the corners, the particle beam is sprayed at an angle. The angle used is identical to the disk shape. This angle can be achieved by either moving the spray gun 1901 or the sample. Since the rectangular sample mold 2802 is not rotating, the tilt incorporates an additional dimension. The fill operation, temperature control, and sample cooling are all identical or substantially identical to the disk setup. Depending on the size and shape of the rectangular mold 2802, the compressed air-cooling setup used in the disk setups may be used and adjusted accordingly to provide the temperature control.

Referring to FIG. 37, following material deposition and once the part has cooled to room temperature, the fasteners 2809 can be removed. The walls 2806 can be easily removed from the build plate 2804 as the deposition does not strongly adhere to the mold walls 2806. The compressive stress is relieved once the fasteners 2809 are removed, and the parts easily slide off the deposition walls 2806.

The near-net shape is left attached on the build plate 2804. For large rectangular parts, removing the build plate 2804 can be challenging. A mix of thermal cycling and mechanical force can be used to separate the two components. The coefficient of thermal expansion between the sprayed material and low carbon steel is similar. Therefore, the heat cycling does not always cause immediate delamination.

There may be cases where it may be useful to cut the near-net shaped part 2700 from the build plate 2804. The cutting operation may use electrical discharge machining (EDM), a diamond saw, or a grinding cut-off wheel to grind material away on a small subset of surfaces, as these techniques are the most efficient. The core-shell particles may include some ceramic materials that wear high speed steel, carbide, and other typical machining cutters too quickly to be effective machining tools. Additionally, the nature of spray-formed powders such as the ones formed by thermal spray do not machine well with high-speed cutters. These cutters cause the material to fracture rather than cut.

### Extensions to the Embodiments Described Herein:

The embodiments described herein may be extended to other powders used in thermal spray processes and may not be limited to strictly core-shell materials. Additionally, other deposition techniques can be used to deposit the powder, for example high velocity oxy-fuel (HVOF) or cold spray or plasma spray can be substituted for the (HVAF) process previously described. The procedures described above can be used to fabricate stator winding cores for hybrid-field motors as well as winding cores for transformers and wireless powder transmission devices that would benefit from 3-dimensional magnetic flow. In addition, the method and apparatus according to the present disclosure may be utilized to produce any applicable components for any suitable applications.

Additionally, other and more complex motor designs can be achieved using the materials, components, and processes described herein. For example, other motor designs such as claw pole or axial flux motors can be achieved.

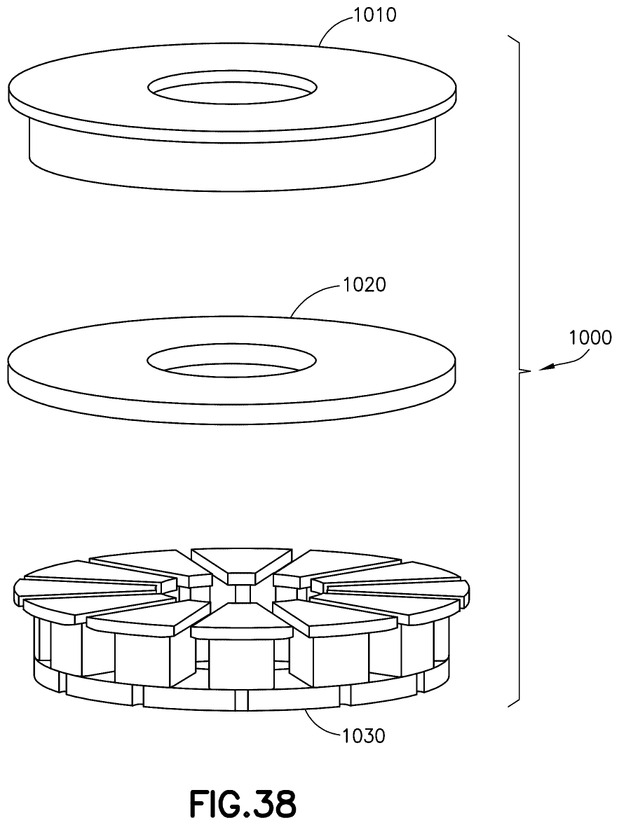

Referring now to FIG. 38, components for an axial flux motor are shown at 1000. Components 1000 include, for example, a tooth ring 1010 and a stator yoke 1020, which may be components used to form a slotted stator core 1030 of an axial flux motor that utilizes three-dimensional flux paths. In motors, efficiency may be limited by iron loss in the stator, the iron loss being comprised of hysteresis and eddy loss components. Some motor designs minimize eddy loss by using laminated electrical steel with insulation between each lamination layer. Soft-magnetic composite materials may overcome design limitations of lamination stacks to allow the three-dimensional flux flow without heat loss, thereby leading to axial flux motor designs.

One example of manufacturing the stator core 1030 for the axial flux motor can be carried out using the near-net fabrication capability. Referring back to FIG. 34, manufacture of the stator core 1030 can be carried out using the multi-step process. In this process, the molds form cavities that match the desired part shape. The powder is spray-deposited into the mold cavity up to a desired fill height, in multiple steps, based on the design of the finished part. Each step in the multi-step process may correspond to a change in feature diameter, where the mold components are changed once the height of the mold walls are filled. Spray facing features may be masked until the mold has been filled to the level of the feature. Once the fill reaches the feature level, the mask(s) are removed, and new mold shapes can be installed. As shown in FIG. 34, the deposition phase 1 results in a part with a hollow cylindrical geometry. Subsequently, deposition phase 2 builds on the material already present but with an increased mold outer and inner diameter to generate the stepped features. When creating cylindrical parts, the target mold is spun about its central axis while the spray beam translates radially creating a spiral fill pattern. This ensures symmetry of part geometry about the central spin axis.

Achieving shapes with vertical walls involves tilting the spray beam at the inside mold corners, as shown in FIG. 24 above. This allows the spray to avoid the vertical walls shadowing the fill location and allows the mold fill to be applied uniformly across the face. In addition, to minimize the amount of voids in the material, mold corners may be machined square without radii or chamfers. TO facilitate adhesion, the build plate and mold surfaces may be grit blasted prior to spray-forming to increase mechanical bonding with the surfaces.

Once the mold cavity has been filled, the material may be removed in a manner that facilitates the re-use of the molds. The mold may be separated into two components, (a) the build plate and (b) the vertical mold walls to allow a multi-step removal process. The build plate, which may be made from low carbon steel, may have relatively low adhesion to the material and may be easily sheared off from the material. If a ductile material, such as aluminum, is used for the build wall the spray generally anchors into the material and will not shear off. With ductile material, one method to separate the part from the build plate is to cut through the material; however, this prevents reuse of the build plate and adds an operation that may be costly.

By shearing the material from the build plate, only the mold walls are holding the part in compression. The sprayed material may be brittle and may not be able to be pressed from the mold without fracturing. Additionally, a release agent such as polytetrafluoroethylene may not remain intact under the heat and mechanical abrasion caused by the spray operation. Therefore, an alternative means of removing the spray-formed part from the mold may be desired. Since the deposited material is in compression, the vertical mold walls, made of aluminum, can be removed by taking advantage of the difference in thermal expansion. Aluminum has an expansion coefficient of 23.3 μm/m-degree C., which is about double that of the deposited material.

Heating the mold and deposited material to an optimal temperature allows the spray-formed part to release from the outer mold. If the geometry being formed has a central hole (for example, as shown in the tooth ring 1010 or the stator yoke 1020) incorporated into the design, then it may be advantageous to selectively cool the center mold component, thereby reducing its size and allowing the mold part to be pressed out of the center of the spray-formed part. Geometries with stepped features (for example, the tooth ring 1010) can be achieved using multi-layer molds (as in FIG. 34). Each mold layer can be removed in the opposite order in which they were added, with the last mold added being the first to be removed.

The molds can be reused for multiple parts. Care should be exercised to prevent damage to the mold when removing the spray-formed part. The mating surfaces may benefit from light sanding to remove any burrs. Gaps between mating surfaces may lead to undesirable material voids, and so an inspection of the part before reuse may be advantageous. Prior to mold re-assembly, the used parts may be grit-blasted. The grit-blasting may refinish the surfaces and may promote adhesion for subsequent parts.

To ensure the use of molds and cavities does not adversely impact magnetic properties, material temperature may be monitored using non-contact infrared pyrometry and controlled to within prescribed limits throughout the mold fill process. During the spray-deposition process, the part temperature may be maintained within a specified temperature range, which may be achieved through active cooling of the part using compressed air.

The spray-facing surface may have a large surface roughness caused by the high velocity particles impacting the surface during deposition. This face may benefit from subsequent machining, via a grinding operation for example, after removal from the mold to ensure the parts correctly mate in the final motor assembly. The axial flux motor 1000 application utilizes the tooth component having slots for prefabricated wire coils. The dimensions of the slots are smaller than the minimum feature size achievable by the current spray equipment used. Therefore, the final conversion from near-net shape to a stator core with winding slots defined between adjacent teeth (as shown in FIG. 6 above) can be cut using wire electrical discharge machining (EMD).

Referring now to FIG. 39, one example embodiment of an axial flux flow motor is shown generally at 1100 and is referred to as “axial flux flow motor 1100.” Axial flux flow motor 1100 comprises a rotor assembly 1110 mounted relative to a stator having a yoke 1112 on which teeth 1114 are mounted and coils 1116 are positioned around the teeth 1114. The stator is mounted in a housing 1118. A bearing sleeve 1120 extends from the rotor assembly 1110, the bearing sleeve 1120 supporting a thrust bearing 1122. A lower end of the rotor assembly 1110 is supported by a radial bearing 1124 at a lower end of the housing 1118. Permanent magnets 1126 are positioned on the rotor assembly 1110.

In one example embodiment, a method of making a stator comprises providing a yoke, wherein the yoke comprises a spray-formed yoke; providing a tooth ring, wherein the tooth ring comprises a spray-formed tooth ring; separating portions of the tooth ring to form a plurality of teeth; arranging the separated teeth in a circular pattern, wherein each separated tooth is spaced from an adjacent tooth; inserting a coil over each separated tooth, wherein the coil comprises two lead wires extending from a same face of each coil; locating the yoke onto the plurality of teeth; placing a housing onto the yoke; and connecting the coils to each other at the two lead wires extending from the same face of each coil.

Each tooth of the plurality of teeth may be wrapped with an electrical insulation tape. The method may further comprise coating each tooth wrapped with the electrical insulation tape with epoxy. Arranging the separated teeth in the circular pattern may comprise arranging the separated teeth on a locating fixture plate. Features on the locating fixture plate may be accommodated between adjacently positioned teeth to align the separated teeth. Placing the housing onto the yoke may comprise orienting the yoke into the housing relative to locating features on the yoke. Connecting the coils to each other at the two lead wires extending from the same face of each coil may comprise connecting the coils in a wye or delta configuration and a series or parallel configuration. Connecting the coils may comprise routing interconnecting wires of the coils along a periphery of the yoke in a ring-shaped volume defined by an outer surface of the yoke, surfaces of the coils, and the housing. The method may further comprise placing a temperature sensing device between adjacently positioned coils. The temperature sensing device may be a thermistor bulb. The spray-formed yoke and the spray-formed tooth ring may be spray-formed in near-net shape manners. The method may further comprise using a magnet to create an attractive force on the yoke to force the yoke to make contact with the teeth.

In another example embodiment, a method of making a stator comprises providing a yoke, wherein the yoke comprises a spray-formed yoke; providing a tooth ring, wherein the tooth ring is a spray-formed tooth ring; separating portions of the tooth ring to form a plurality of teeth; arranging the separated teeth in a circular pattern, wherein each separated tooth is spaced from an adjacent tooth; inserting a coil over each separated tooth; locating the yoke onto the plurality of teeth; placing the yoke into an encapsulation mold; connecting the coils to each other; and injecting a resin into the encapsulation mold.

The method may further comprise removing the encapsulation mold. Injecting the resin into the encapsulation mold may comprise injecting the resin into an inlet port at a bottom of the encapsulation mold and allowing the resin to flow between the coils and exit an outlet port at a top of the encapsulation mold. The resin may be heated to a temperature above a set temperature to lower viscosity of the resin to allow the resin to flow with a viscosity such that spaces between the separated teeth, the coils, and the yoke are filled. The spray-formed yoke and the spray-formed tooth ring may be spray-formed in near-net shape manners. The method may further comprise using a magnet to create an attractive force on the yoke to force the yoke to make contact with the teeth.

In another example embodiment, a method of assembling a stator/rotor assembly for a motor comprises providing a housing having a bearing sleeve, the bearing sleeve extending radially inward in the housing; providing a stator, wherein the stator comprises, a spray-formed stator yoke, a plurality of teeth arranged in spaced relationship on the stator yoke, and a coil inserted over each of the separated teeth and connected to coils inserted over adjacent separated teeth; mounting the stator in the housing on the bearing sleeve; mounting bearings proximate the bearing sleeve; and mounting a rotor comprising a rotor yoke and a plurality of magnets on the bearing sleeve, wherein mounting the rotor on the bearing sleeve comprises inserting the rotor into the housing using a gradual and controlled insertion such that an air gap is formed between the stator and the rotor, the air gap being substantially planar and normal to an axis of rotation of the rotor relative to the stator.

The coils may be connected to each other in a wye or delta configuration and a series or parallel configuration. Mounting the bearings proximate the bearing sleeve may comprise assembling an axial thrust bearing onto the bearing sleeve. Mounting the bearings proximate the bearing sleeve may comprise assembling a radial bearing onto the bearing sleeve. Assembling the radial bearing onto the bearing sleeve may comprise using magnetic attraction to eliminate axial clearance between the rotor yoke and the plurality of teeth.

In another example embodiment, a stator for a three-dimensional flux electric motor comprises a stator yoke; a plurality of teeth arranged on the stator yoke, wherein teeth of the plurality of teeth are spaced from each other; and a coil located over each tooth, the coils over each tooth being connected to coils on adjacent teeth. Each tooth of the plurality of teeth includes a body portion having three sides connected along respective opposing side edges, each of the three sides having a bottom edge and a top edge adjacent to the opposing side edges, and a top portion located on the top edges. The top portion of each tooth includes an overhang portion that overhangs the top edges of the body portion. Each tooth of the plurality of teeth provides for at least a magnetic flux flow in axial, radial, and circumferential directions.

The overhang portion may provide for at least a portion of the magnetic flux flow in the tooth in the radial and the circumferential directions. The three opposing sides of the body portion may include chamfered or rounded outside corners at the connected edges defining the three sides. The bottom edges of the three sides may each include a fillet at an inside corner formed by a respective side of the body portion and the stator yoke. The teeth of the plurality of teeth may be formed from an isotropic soft-magnetic composite material. The stator yoke may be spray-formed in a near-net shape manner. The plurality of teeth may be formed from a tooth ring spray-formed in a near-net shape manner, and the spray-formed tooth ring may be separated into the plurality of teeth. The stator yoke may comprise a planar disk having at least one feature located on a surface thereof, the at least one feature being configured to locate the stator within a housing. The housing may comprise a unitary piece of aluminum to provide a continuous heat conduction path from the coil. The stator may be mounted in a housing having a bearing sleeve extending radially inward in the housing. An axial thrust bearing and a radial thrust bearing may be positioned on the bearing sleeve. The teeth and coils of the stator may be encapsulated in an epoxy resin. Clearances may be formed between the teeth and the coils, the coils and a housing, and the stator yoke and the housing to accommodate the epoxy resin to facilitate bonding.

In another example embodiment, a three-dimensional flux electric motor comprises a housing comprising a bearing sleeve extending radially inward in the housing; at least one stator mounted on the bearing sleeve in the housing, the at least one stator comprising, a spray-formed stator yoke, a plurality of teeth arranged on the stator yoke and spaced from each other, and a coil over each tooth, the coils over each tooth being connected to coils on adjacent teeth, each tooth of the plurality of teeth including a body portion having three sides, each of the three sides having a bottom edge and a top edge and a top portion located on the top edges, the top portion including an overhang portion that overhangs the top edges of the body portion, each tooth of the plurality of teeth providing for a magnetic flux flow in axial, radial, and circumferential directions; and at least one rotor mounted on the bearing sleeve, the at least one rotor comprising, a rotor yoke, and a plurality of magnets on the rotor yoke. The at least one stator and the at least one rotor are separated by an air gap.

The overhang portion of the top portion of each tooth may provide for the magnetic flux flow in the radial and the circumferential directions. The teeth of the plurality of teeth may be formed from an isotropic soft-magnetic composite material. At least a portion of the stator may be spray-formed in a near-net shape manner.

In another example embodiment, a stator for an axial flux motor comprises: a yoke, a plurality of teeth arranged on the yoke and spaced from each other, each tooth of the plurality of teeth comprising a sprayed soft-magnetic composite material comprising a matrix of ferro-magnetic domains separated by insulation layers, and a prefabricated coil over each tooth, the coil over each tooth being connected to coils on adjacent teeth. Each tooth of the plurality of teeth includes a body portion having three sides, each of the three sides having a bottom edge and a top edge, and a top portion located on the top edges. The top portion includes an overhang portion that overhangs the top edges of the body portion. Each tooth of the plurality of teeth provides for a magnetic flux flow in the spray-formed composite material in axial, radial, and circumferential directions.

The matrix of ferro-magnetic domains separated by insulation layers may be formed from particles of a powder, wherein a particle of the powder comprises a core-shell structure having a core of ferro-magnetic material covered by a shell of insulating material reactively formed with the ferro-magnetic material. The core of ferro-magnetic material may comprise at least one of iron, cobalt, or nickel, and the shell of insulating material may comprise a ceramic. The core-shell structures may be from 50 micrometers to 100 micrometers in diameter, and the shell of insulating material may be 100 nanometers to 150 nanometers in thickness. The soft-magnetic composite material may be configured to be sprayed using a high velocity air fuel system or a high velocity oxy-fuel system. The matrix of ferro-magnetic domains separated by insulation layers may comprise a plurality of the ferro-magnetic domains separated by the insulation layers mechanically interlocked and held in compression. A density of the matrix of ferro-magnetic domains separated by insulation layers may be about 6280 kilograms per cubic meter. In an alternative embodiment, a density of the matrix of ferro-magnetic domains separated by insulation layers may be in a range between 6000-7000 kilograms per cubic meter. The plurality of teeth arranged on the yoke and spaced from each other may be formed from a spray-formed tooth ring, the spray-formed tooth ring being spray-formed in a near-net manner.

In another example embodiment, a method of making a stator for an axial flux flow motor comprises: providing a yoke; spray-forming a tooth ring as a sprayed soft-magnetic composite material comprising a matrix of ferro-magnetic domains separated by insulation layers; separating portions of the tooth ring to form a plurality of teeth; arranging the separated teeth in a circular pattern, wherein each separated tooth is spaced from an adjacent tooth; inserting a coil over each separated tooth, wherein the coil comprises two lead wires extending from a same face of each coil; locating the yoke onto the plurality of teeth; placing a housing onto the yoke; and connecting the coils to each other at the two lead wires extending from the same face of each coil.

Spray-forming the tooth ring may comprise spraying particles of a powder using a high velocity air fuel system or a high velocity oxy-fuel system, wherein a particle of the powder may comprise a core-shell structure having a core of ferro-magnetic material covered by a shell of insulating material reactively formed with the ferro-magnetic material. Spray-forming the tooth ring comprising spraying particles of the powder using a high velocity air fuel system or a high velocity oxy-fuel system may comprise heating the particles of the powder to a temperature sufficient to soften the core of ferro-magnetic material. Spray-forming the tooth ring may also comprise spraying the heated particles of the powder at a speed sufficient to cause the heated particles to bind together. Spray-forming the tooth ring may cause the ferro-magnetic domains and insulation layers separating the ferro-magnetic domains to mechanically interlock and be held in compression. Spray-forming the tooth ring may comprise spray-forming the sprayed soft-magnetic composite material comprising a matrix of ferro-magnetic domains separated by insulation layers in a near-net shape manner. Spray-forming the tooth ring may comprise spraying the soft-magnetic composite material in a radial pattern onto a spinning target. The method may further comprise regulating a temperature of the sprayed soft-magnetic composite material to minimize fracturing of the shell of insulating material.

In another example embodiment, a method of forming a motor component in a near-net manner comprises providing a mold as a target, the mold having a cavity defined therein; spinning the mold about an axis extending through a center of the build plate; translating a spray gun of a spray-deposition system in a radial direction relative to the axis; spraying, from the spray-deposition system, a beam of soft-magnetic composite material comprising particles having a core-shell structure, onto the mold; angling the beam of sprayed soft-magnetic composite material at an inside corner defined by at least two walls of the mold; and removing the motor component formed by the sprayed soft-magnetic composite material from the mold.

The method may further comprise machining the inside corner defined by the at least two walls of the mold to reduce a radii or a chamfered surface. The method may further comprise grit blasting a surface of the mold. The method may further comprise sanding a surface of the mold. Removing the motor component formed by the sprayed soft-magnetic composite material from the mold may comprise shearing the mold off of the motor component. Removing the motor component formed by the sprayed soft-magnetic composite material from the mold may comprise cutting the motor component from the mold. Removing the motor component formed by the sprayed soft-magnetic composite material from the mold may comprise heating the mold.

In another example embodiment, an axial flux motor comprises a housing comprising a bearing sleeve axially positioned in the housing; at least one stator mounted on the bearing sleeve, the at least one stator comprising a spray-formed stator yoke, a plurality of teeth arranged on the spray-formed stator yoke and spaced from each other, each tooth of the plurality of teeth comprising a sprayed soft-magnetic composite material comprising a matrix of ferro-magnetic domains separated by insulation layers, and a prefabricated coil over each tooth, the coil over each tooth being connected to coils on adjacent teeth. Each tooth of the plurality of teeth includes a body portion having three sides, each of the three sides having a bottom edge and a top edge, and a top portion located on the top edges, wherein the top portion includes an overhang portion that overhangs the top edges of the body portion, and wherein each tooth of the plurality of teeth provides for a magnetic flux flow in the spray-formed soft-magnetic composite material in axial, radial, and circumferential directions. The axial flux motor also comprises at least one rotor mounted on the bearing sleeve, the at least one rotor comprising, a rotor yoke, and a plurality of magnets on the rotor yoke, wherein the at least one spray-formed stator and the at least one rotor are separated by an air gap.

The matrix of ferro-magnetic domains separated by insulation layers may be formed from particles of a powder, wherein a particle of the powder comprises a core-shell structure having a core of ferro-magnetic material covered by a shell of insulating material reactively formed with the ferro-magnetic material. The core of ferro-magnetic material may comprise at least one of iron, cobalt, or nickel, and the shell of insulating material may comprise a ceramic. The at least the tooth ring may be formed in a near-net shape manner.

Features as described herein may be provided in an apparatus. Features as described herein may be provided in a method of assembly for assembling an apparatus. Features as described herein may be provided in a method of using an apparatus with features as described above. Features as described herein may be provided in control software, embodied in a memory and capable of use with a processor, or controlling an apparatus with movement as described above.

It should be understood that the foregoing description is only illustrative. Various alternatives and modifications can be devised by those skilled in the art. In addition, features from different embodiments described above could be selectively combined into a new embodiment.

What is claimed is:

1. A stator for an axial flux motor, the stator comprising:
a yoke,
a plurality of teeth arranged on the yoke and spaced from each other, each tooth of the plurality of teeth comprising a sprayed soft-magnetic composite material comprising a matrix of ferro-magnetic domains separated by insulation layers, and
a prefabricated coil over each tooth, the coil over each tooth being connected to coils on adjacent teeth,
wherein each tooth of the plurality of teeth includes a body portion having three sides, each of the three sides having a bottom edge and a top edge, and a top portion located on the top edges,
wherein the top portion includes an overhang portion that overhangs the top edges of the body portion, and
wherein each tooth of the plurality of teeth provides for a magnetic flux flow in the spray-formed composite material in axial, radial, and circumferential directions.

2. The stator of claim 1, wherein the matrix of ferro-magnetic domains separated by insulation layers is formed from particles of a powder, wherein a particle of the powder comprises a core-shell structure having a core of ferro-magnetic material covered by a shell of insulating material reactively formed with the ferro-magnetic material.

3. The stator of claim 2, wherein the core of ferro-magnetic material comprises at least one of iron, cobalt, or nickel, and wherein the shell of insulating material comprises a ceramic.

1. The stator of claim 2, wherein the core-shell structures are from 50 micrometers to 100 micrometers in diameter, and wherein the shell of insulating material is 100 nanometers to 150 nanometers in thickness.

2. The stator of claim 1, wherein the soft-magnetic composite material is configured to be sprayed using a high velocity air fuel system or a high velocity oxy-fuel system.

3. The stator of claim 1, wherein the matrix of ferro-magnetic domains separated by insulation layers comprises a plurality of the ferro-magnetic domains separated by the insulation layers mechanically interlocked and held in compression.

4. The stator of claim 1, wherein a density of the matrix of ferro-magnetic domains separated by insulation layers is between 6000 and 7000 kilograms per cubic meter.

5. The stator of claim 1, wherein the plurality of teeth arranged on the yoke and spaced from each other are formed from a spray-formed tooth ring, the spray-formed tooth ring being spray-formed in a near-net manner.

6. A method of making a stator for an axial flux flow motor, the method comprising:
providing a yoke;
spray-forming a tooth ring as a sprayed soft-magnetic composite material comprising a matrix of ferro-magnetic domains separated by insulation layers;
separating portions of the tooth ring to form a plurality of teeth;
arranging the separated teeth in a circular pattern, wherein each separated tooth is spaced from an adjacent tooth;
inserting a prefabricated coil over each separated tooth, wherein the coil comprises two lead wires extending from a same face of each coil;
locating the yoke onto the plurality of teeth;
placing a housing onto the yoke; and
connecting the coils to each other at the two lead wires extending from the same face of each coil.

7. The method of claim 9, wherein spray-forming the tooth ring comprises spraying particles of a powder using a high velocity air fuel system or a high velocity oxy-fuel system, wherein a particle of the powder comprises a core-shell structure having a core of ferro-magnetic material covered by a shell of insulating material reactively formed with the ferro-magnetic material.

8. The method of claim 10, wherein spray-forming the tooth ring comprises spraying particles of the powder using a high velocity air fuel system or a high velocity oxy-fuel system comprises heating the particles of the powder to a temperature sufficient to soften the core of ferro-magnetic material.

9. The method of claim 11, wherein spray-forming the tooth ring comprises spraying the heated particles of the powder at a speed sufficient to cause the heated particles to bind together.

10. The method of claim 9, wherein spray-forming the tooth ring causes the ferro-magnetic domains and insulation layers separating the ferro-magnetic domains to mechanically interlock and be held in compression.

11. The method of claim 9, wherein spray-forming the tooth ring comprises spray-forming the sprayed soft-magnetic composite material comprising a matrix of ferro-magnetic domains separated by insulation layers in a near-net shape manner.

12. The method of claim 9, wherein spray-forming the tooth ring comprises spraying the soft-magnetic composite material in a radial pattern onto a spinning target.

13. The method of claim 10, further comprising regulating a temperature of the sprayed soft-magnetic composite material to minimize fracturing of the shell of insulating material.

14. A method of forming a motor component in a near-net manner, the method comprising:
providing a mold as a target, the mold having a cavity defined therein;
spinning the mold about an axis extending through a center of the mold;
translating a spray gun of a spray-deposition system in a radial direction relative to the axis;
spraying, from the spray-deposition system, a beam of soft-magnetic composite material comprising particles having a core-shell structure, onto the mold;
angling the beam of sprayed soft-magnetic composite material at an inside corner defined by at least two walls of the mold; and
removing the motor component formed by the sprayed soft-magnetic composite material from the mold.

15. The method of claim 17, further comprising machining the inside corner defined by the at least two walls of the mold to reduce a radii or a chamfered surface.

16. The method of claim 17, further comprising grit blasting a surface of the mold.

17. The method of claim 17, further comprising sanding a surface of the mold.

18. The method of claim 17, wherein removing the motor component formed by the sprayed soft-magnetic composite material from the mold comprises shearing the mold off of the motor component.

19. The method of claim 17, wherein removing the motor component formed by the sprayed soft-magnetic composite material from the mold comprises cutting the motor component from the mold.

20. The method of claim 17, wherein removing the motor component formed by the sprayed soft-magnetic composite material from the mold comprises heating the mold.

21. An axial flux motor, comprising:
a housing comprising a bearing sleeve axially positioned in the housing;
at least one stator mounted on the bearing sleeve, the at least one stator comprising,
a spray-formed stator yoke,
a plurality of teeth arranged on the spray-formed stator yoke and spaced from each other, each tooth of the plurality of teeth comprising a sprayed soft-magnetic composite material comprising a matrix of ferro-magnetic domains separated by insulation layers, and
a coil over each tooth, the coil over each tooth being connected to coils on adjacent teeth,
wherein each tooth of the plurality of teeth includes a body portion having three sides, each of the three sides having a bottom edge and a top edge, and a top portion located on the top edges,
wherein the top portion includes an overhang portion that overhangs the top edges of the body portion, and
wherein each tooth of the plurality of teeth provides for a magnetic flux flow in the spray-formed soft-magnetic composite material in axial, radial, and circumferential directions; and
at least one rotor mounted on the bearing sleeve, the at least one rotor comprising,
a rotor yoke, and
a plurality of magnets on the rotor yoke,
wherein the at least one spray-formed stator and the at least one rotor are separated by an air gap.

22. The axial flux motor of claim 24, wherein the matrix of ferro-magnetic domains separated by insulation layers is formed from particles of a powder, wherein a particle of the powder comprises a core-shell structure having a core of ferro-magnetic material covered by a shell of insulating material reactively formed with the ferro-magnetic material.

23. The axial flux motor of claim 25, wherein the core of ferro-magnetic material comprises at least one of iron, cobalt, or nickel, and wherein the shell of insulating material comprises a ceramic.

24. The axial flux motor of claim 24, wherein at least the tooth ring is formed in a near-net shape manner.
